(19) United States
(12) Patent Application Publication
(10) Pub. No.: US 2017/0368816 A1
(43) Pub. Date: Dec. 28, 2017

(54) RESIN SLOT EXTRUDER FOR ADDITIVE MANUFACTURING SYSTEM

(71) Applicant: Stratasys, Inc., Eden Prairie, MN (US)

(72) Inventors: J. Samuel Batchelder, Somers, NY (US); Moshe Aknin, Modi'in-Maccabim-Reut (IL); Jonathan B. Hedlund, Blaine, MN (US)

(21) Appl. No.: 15/538,824

(22) PCT Filed: Dec. 18, 2015
(86) PCT No.: PCT/US2015/066745

§ 371 Date: Jun. 22, 2017

Related U.S. Application Data
(60) Provisional application No. 62/096,169, filed on Dec. 23, 2014.

(51) Int. Cl. B33Y 30/00; B29C 31/02; B29C 35/02; B29C 64/112; B29C 39/14; B29C 64/223; B29C 67/00; B29C 47/00; B29C 47/08; B29C 47/86

(52) U.S. Cl. CPC B33Y 30/00; B29C 64/223; B29C 31/02; B29C 35/0266; B29C 67/0025; B29C 64/112; B29C 39/146; B29C 47/0813; B29C 47/0866; B29C 47/862; B29C 47/0019

(57) ABSTRACT

A slot extruder for use with an additive manufacturing system, which includes a plenum configured to receive a photocurable resin, an elongated slot positioned at a bottom end of the plenum and configured to receive the photocurable resin from the plenum, one or more resin inlet ports extending into the plenum, and one or more mechanisms configured to controllably pressurize and depressurize the photocurable resin in the plenum.

### BACKGROUND

The present disclosure relates to additive manufacturing systems and processes for printing or otherwise building three-dimensional (3D) parts with layer-based, additive manufacturing techniques. In particular, the present disclosure relates to systems for printing 3D parts using optical-based additive manufacturing techniques.

Additive manufacturing systems are used to print or otherwise build 3D parts from digital representations of the 3D parts (e.g., STL format files) using one or more additive manufacturing techniques. Examples of commercially available additive manufacturing techniques include extrusion-based techniques, jetting, selective laser sintering, powder/binder jetting, electron-beam melting, digital light processing, and stereolithographic processes. For each of these techniques, the digital representation of the 3D part is initially sliced into multiple horizontal layers. For each sliced layer, a tool path or image is then generated, which provides instructions for the particular additive manufacturing system to print the given layer.

For example, in an extrusion-based additive manufacturing system, a 3D part may be printed from a digital representation of the 3D part in a layer-by-layer manner by extruding a flowable part material. The part material is extruded through an extrusion tip carried by a print head of the system, and is deposited as a sequence of roads on a substrate in an x-y plane. The extruded part material fuses to previously deposited part material, and solidifies upon a drop in temperature. The position of the print head relative to the substrate is then incremented along a z-axis (perpendicular to the x-y plane), and the process is then repeated to form a 3D part resembling the digital representation.

In another example, in a stereolithography-based additive manufacturing system, a 3D part may be printed from a digital representation of the 3D part in a layer-by-layer manner by tracing a laser beam across a vat of photocurable resin. For each layer, the laser beam draws a cross-section for the layer on the surface of the liquid resin, which cures and solidifies the drawn pattern. After the layer is completed, the system's platform is lowered by a single layer increment. A fresh portion of the resin may then recoat the previous layer, and the laser beam may draw across the fresh resin to pattern the next layer, which joins the previous layer. This process may then be repeated for each successive layer. Afterwards, the uncured resin may be cleaned, and the resulting 3D part may undergo subsequent curing.

### SUMMARY

An aspect of the present disclosure is directed to a slot extruder for use with an additive manufacturing system. The slot extruder includes a plenum configured to receive a photocurable resin, an elongated slot positioned at a bottom end of the plenum and configured to receive the photocurable resin from the plenum, and one or more resin inlet ports extending into the plenum. The slot extruder also preferably includes one or more mechanisms configured to controllably pressurize and depressurize the photocurable resin in the plenum.

Another aspect of the present disclosure is directed to a selectively-operated slot extruder for use with an additive manufacturing system, which includes a plenum configured to receive a photocurable resin, an elongated slot configured to receive the photocurable resin from the plenum, and a plurality of resin inlet ports extending into the plenum. The slot extruder also includes one or more heater array assemblies configured to receive commands from a controller assembly of the additive manufacturing system.

Another aspect of the present disclosure is directed to an additive manufacturing system, which includes a build platen, a platen gantry configured to move the platen along a first axis, a laser assembly comprising a plurality of individually-operable laser emitters, and one or more slot extruders configured to extrude one or more photocurable resin films over the platen. The system also includes one or more gantries configured to move the laser assembly and the one or more slot extruders along a scan length axis such that each of the plurality of laser emitters traverses across the platen, and such that each of the one or more slot extruders traverses across the platen. The system further includes a controller assembly configured to operate the platen gantry, the laser assembly, the one or more slot extruders, and the one or more gantries to print three-dimensional parts on the platen in a layer-by-layer manner from the photocurable resin films.

Another aspect of the present disclosure is directed to an additive manufacturing system that includes a build platen, a platen gantry configured to move the platen along a first axis, one or more imaging devices configured to emit laser beams, and one or more slot extruders configured to extrude one or more photocurable resin films over the platen. The system also includes one or more gantries configured to move the slot extruders along a scan length axis such that each of the one or more slot extruders traverses across the platen, and a controller assembly configured to operate the platen gantry, the one or more imaging devices, the one or more slot extruders, and the one or more gantries to print one or more three-dimensional parts on the platform in a layer-by-layer manner from the photocurable resin films.

### DEFINITIONS

Unless otherwise specified, the following terms as used herein have the meanings provided below:

The term “additive manufacturing system” refers to a system that prints, builds, or otherwise produces 3D parts and/or support structures at least in part using an additive manufacturing technique. The additive manufacturing system may be a stand-alone unit, a sub-unit of a larger system or production line, and/or may include other non-additive manufacturing features, such as subtractive-manufacturing features, pick-and-place features, two-dimensional printing features, and the like.

The terms “command”, “commanding”, and the like, with reference to a controller assembly commanding a device (e.g., a laser emitter, a gantry, a motor, or the like), refers to the direct and/or indirect relaying of control signals from the controller assembly to the device such that the device operates in conformance with the relayed signals. The signals may be relayed in any suitable form, such as communication signals to a microprocessor on the device, applied electrical power to operate the device, and the like.

The term “polymer” includes both homopolymers and copolymers (e.g., polymers of two or more different monomers). Correspondingly, the term “copolymer” refers to a polymer having two or more monomer species, and includes terpolymers (i.e., copolymers having three monomer species).

The terms “at least one” and “one or more of” an element are used interchangeably, and have the same meaning that includes a single element and a plurality of the elements, and may also be represented by the suffix “(s)” at the end of the element. For example, “at least one copolymer”, “one or more copolymers”, and “copolymer(s)” may be used interchangeably and have the same meaning.

The term “(meth)acrylate” includes acrylate and methacrylate. Similarly, the term “(meth)acrylic acid” includes acrylic acid and methacrylic acid.

The term “providing”, such as for “providing a device”, when recited in the claims, is not intended to require any particular delivery or receipt of the provided item. Rather, the term “providing” is merely used to recite items that will be referred to in subsequent elements of the claim(s), for purposes of clarity and ease of readability.

Unless otherwise specified, temperatures referred to herein are based on atmospheric pressure (i.e. one atmosphere).

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the present disclosure.

The terms “about” and “substantially” are used herein with respect to measurable values and ranges due to expected variations known to those skilled in the art (e.g., limitations and variabilities in measurements).

### BRIEF DESCRIPTION OF THE DRAWINGS

FIG. 1 is a top view of an additive manufacturing system having slot extruders of the present disclosure and a laser assembly positioned on a first side of the system.

FIG. 2 is a side view of the additive manufacturing system shown in FIG. 1.

FIG. 3 is a top view of the additive manufacturing system with slot extruders and laser assembly positioned on a second side of the system.

FIG. 4 is a side view of the additive manufacturing system shown in FIG. 3.

FIG. 5 is a top view of the additive manufacturing system, illustrating a 3D part being printed with the slot extruders and laser assembly.

FIG. 6 is a side view of the additive manufacturing system shown in FIG. 5.

FIG. 7 is a top view of the 3D part being printed, illustrating a resin film extrusion area.

FIG. 8 is a view of the 3D part being printed, illustrating a resin film extrusion area that is reduced along an axis of travel

FIG. 9 is a view of the 3D part being printed, illustrating a resin film extrusion area that is also reduced along a span axis.

FIGS. 9A and 9B are views of the 3D part being printed, illustrating printed containment dikes for the resin film.

FIG. 10 is a perspective view of the slot extruder extruding and applying a resin film.

FIG. 11 is an expanded side view of the slot extruder extruding and applying the resin film on a working surface, where a lateral end wall of the slot extruder is omitted.

FIG. 12 is an englarged side view of the slot extruder illustrated in FIG. 11.

FIG. 13 is a perspective view of a portion of an embodiment of the slot extruder extruding and applying a resin film, where an end wall of the slot extruder is omitted.

FIG. 14 is an englarged side view of the slot extruder illustrated in FIG. 13.

FIG. 15 is a top perspective view of the slot extruder illustrated in FIG. 13, where a lateral end wall and a top cover of the slot extruder are omitted.

FIG. 16 is an enlarged perspective view of a plenum of the slot extruder illustrated in FIG. 13.

FIG. 17 is another enlarged perspective view of a slot of a plenum illustrated in FIG. 16.

FIG. 18 is a further enlarged perspective view of the slot illustrated in FIG. 17.

FIG. 19 is a top view of an alternative additive manufacturing system having multiple slot extruders, such as for multiple-material applications.

FIG. 20 is a perspective view of the slot extruder illustrated in FIG. 19 extruding and applying a resin film.

### DETAILED DESCRIPTION

The present disclosure is directed to a slot extruder for use in an additive manufacturing system, where the slot extruder is configured to apply films of one or more photocurable resins, preferably under low-shear conditions. The slot extruder may be used in combination with an imaging device of the additive manufacturing system (e.g., a laser assembly), where the imaging device is configured to selectively cross-link each extruded resin film in a predefined pattern to print a 3D part in a layer-by-layer manner As discussed below, the slot extruder can apply substantially uniform films of photocurable resins, including viscous photocurable resins, at fast rates and with large surface areas.

Current additive manufacturing techniques with photocurable resin films, such as stereolithography (SLA) and digital light process (DLP) 3D printers, use a variety of different techniques for applying photopolymer layers to a part under construction. These techniques typically include submerging the 3D part into a resin vat, trapping resin between the surface of the 3D part and a transparent low-surface-energy window, impelling a wave across the 3D part with a counter-rotating cylinder, applying and peeling a web carrying a resin layer, and passing a doctor blade across the resin layer on the 3D part.

Each of these techniques attempt to distribute the flowable resin over the surface of the 3D part, level the resin to a uniform z-height increment, and allow the polymerizing optical energy (e.g., a laser beam) to reach the applied resin. However, these techniques develop problems when the layer surface area of the 3D part is large, and when the resin being applied has a high viscosity. Additional problematic factors can also include short times between the printing of the layers, small printed features, and multiple-material applications.

There are several root causes of these problems. First, attempts to quickly level a high-viscosity material against a surface can generate destructive, in-plane shear stress on the part surface. Additionally, the disengagement of a z-height defining surface, such as a web or window, can generate destructive normal stresses on the part surface. Furthermore, shearing one photopolymer on top of a different photopolymer can induce resin mixing, which typically produces an undesirable intermediate state material.

These deficiencies can become readily apparent when attempting to print 3D parts with a laser assembly having arrays of hundreds or thousands of laser diodes, such as discussed in Batchelder et al., Patent Application Ser. No. 62/083,553, entitled “Additive Manufacturing System With Laser Assembly” (“the '553 application”) and International Application Serial No. PCT/US2015/062388, the contents of both are incorporated by reference in their entireties. The laser assemblies discussed in the '553 application and the '388 International application are preferably capable of printing with high-viscosity, flowable photocurable resins (e.g., from 50-5,000 centipoise), thin layers (e.g., 10-100 micrometers), high printing speeds (e.g., 30-150 inches/second), and short layer times (e.g., 0.5-10 seconds).

As can be appreciated, current techniques for applying the resin layers are not capable of meeting these demands By way of example, a one-inch diameter roller that counter-rolls across a one-meter wide 3D part surface at 50 inches/second, applying a 100-inches/second effective surface velocity difference over a 50-micrometer gap filled with 10 poise resin, will place about 30 pounds-force (about 130 Newtons) of in-plane shear force on the surface of the 3D part. The imparted shear force is sufficient to mechanically distort the 3D part and/or break off fine feature details.

One alternative to this design may include slowing down the application of the resin layers. However, this would significantly impede the overall printing operation, and substantially counteract the benefits of a high-speed laser assembly.

To overcome the above-mentioned deficiencies, the slot extruder of the present disclosure is capable of applying a high-viscosity, flowable photocurable resin to a surface at high speeds with minimal or otherwise reduced levels of stress applied to the surface. More particularly, the slot extruder preferably shears the photocurable resin within the extruder to define the resin film thickness, and then apply the resin film to the part surface with minimal (or otherwise substantially reduced) amounts of normal and shear forces. This allows 3D parts to be printed from photocurable resins having high viscosities (for increased part strengths and film-deformation resistance), thin layers (for good part resolutions), high printing speeds and short layer times (for reduced printing durations and increased protection).

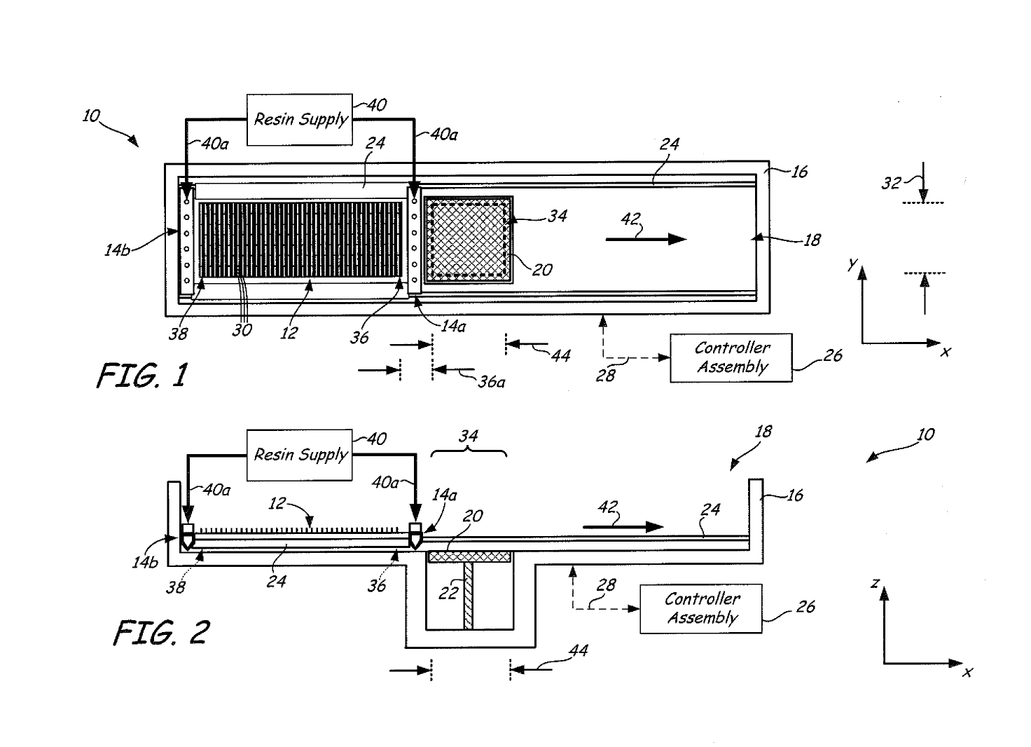

FIGS. 1 and 2 illustrate an exemplary non-limiting system 10 that includes a laser assembly 12 in use with a pair of spaced apart slot extruders 14 of the present disclosure (individually referred to as slot extruders 14a and 14b). In this non-limiting example, system 10 also includes housing 16 having a working region 18 generally defining a T-shape arrangement. Housing 16 also typically and optionally has an enclosable lid or casing to enclose working region 18 during operation.

The following discussion describes the components of the example system 10, as shown in FIGS. 1 and 2, and how they operate with slot extruders 14. However, slot extruders 14 may alternatively be used with any suitable additive manufacturing system for printing 3D parts from photocurable resin films, such as but not limited to, stereolithography (SLA) 3D printers, digital light processing (DLP) 3D printers, and the like.

In the shown embodiment, system 10 also includes platform 20 and platform gantry 22 (shown in FIG. 2), where platform 20 is a receiving surface for printing the 3D parts in a layer-by-layer manner. Platform gantry 22 is an assembly configured to controllably move platform 20 along (or substantially along) the vertical z-axis within, such as in incremental steps. This allows platform 20 to be lowered incrementally to print each layer of a 3D part. Platform gantry 22 may operate to move platform 20 with one or more motors (e.g., stepper motors and encoded DC motors), gears, pulleys, belts, screws, linear bearings and rails, and the like.

Laser assembly 12 and slot extruders 14 are mounted in working region 18, above the height of platform 20, with gantry 24. Gantry 24 is configured to controllably move laser assembly 12 and slot extruders 14 back-and-forth along the x-axis (scan direction axis) within overhead region 18. Gantry 24 may operate to move laser assembly 12 with one or more motors (e.g., stepper motors and encoded DC motors), gears, pulleys, belts, screws, linear bearings and rails, and the like.

In some embodiments, gantry 24 also prevents or otherwise restricts laser assembly 12 and slot extruders 14 from moving along the y-axis (swath direction axis) and/or the z-axis. However, in other embodiments, gantry 24 may controllably move laser assembly 12 and slot extruders 14 along the y-axis, such as in small randomized offsets along the y-axis to overcome potential laser failures. In yet further alternative embodiments, gantry 24 may controllably move laser assembly 12 and slot extruders 14 along the z-axis, if desired. Gantry 24 also preferably prevents laser assembly 12 and slot extruders 14 from roll, pitch, or yaw movements relative to platform 20.

System 10 also includes controller assembly 26, which is one or more computer-based systems and/or one or more control circuits configured to monitor and operate the components of system 10, such as laser assembly 12, slot extruders 14, motors for platen gantry 22, gantry 24, and various sensors, calibration devices, display devices, and/or user input devices. For example, one or more of the control functions performed by controller assembly 26 can be implemented in hardware, software, firmware, and the like, or combinations thereof.

Controller assembly 26 may communicate over communication line 28 with the various components of system 10, such as laser assembly 12, slot extruders 14, motors for platen gantry 22, gantry 24, and various sensors, calibration devices, display devices, and/or user input devices. While communication line 28 is illustrated as a single signal line, it may include one or more electrical, optical, and/or wireless signal lines and intermediate control circuits, allowing controller assembly 26 to communicate with various components of system 10.

Controller assembly 26 may also include one or more computer-based systems having computer-based hardware, such as data storage devices, processors, memory modules and the like for generating, storing, and transmitting tool path and related printing instructions to system 10. Furthermore, one or more portions of controller assembly 26 may be retained by laser assembly 12. For instance, controller assembly 26 may include one or more intermediate controllers mounted to laser assembly 12 and slot extruders 14, which may relay data (e.g., compressed image data and timing information) to additional control boards of laser assembly 12 (e.g., laser driver boards), and/or to additional control boards of slot extruders 14 (e.g., heater driver boards).

Laser assembly 12 is an exemplary, non-limiting laser array assembly for use with slot extruders 14, and preferably includes multiple arrays of laser emitters 30, where each laser emitter 30 that can be selectively and independently operated to emit laser beams on a voxel-by-voxel basis. The emitted laser beams from laser emitters 30 selectively cross-link the resin film in a predefined pattern to form a layer of a 3D part. Examples laser array assemblies for laser assembly 12 include those disclosed in the '553 application and the '388 International application.

As can be seen in FIG. 1, the arrays of laser emitters 30 are separated along the y-axis to define a swath width 32. Swath width 32 can define the maximum y-axis limits for a build envelope in which a 3D part may be printed, referred to as build envelope 34. As discussed below, swath width 32 can be any reasonably desired distance, and preferably does not directly affect the printing speeds for system 10.

Laser emitters 30 may also be arranged in a series of y-axis rows that include a leading row 36 and a trailing row 38, and which are offset along the x-axis. The terms “leading” and “trailing” are used for convenience, and are not intended to limit the use of laser assembly 12. As will be discussed below, gantry 24 is configured to controllably move laser assembly 12 and slot extruders 14 in back-and-forth directions along the x-axis for printing layers. With laser assembly 12 at the left-side set position in overhead region 18, as shown in FIGS. 1 and 2, the leading row 36 of laser emitters 30 is located to the left side of build envelope 34 by a distance 36a (shown in FIG. 1), which accounts for accelerations and decelerations of laser assembly 12 and slot extruders 14.

Slot extruders 14 of the present disclosure are a pair of opposing resin slot extruders to producing film of a photocurable resin for each layer of the 3D part, as discussed below. In the shown example, slot extruder 14a is operably mounted to laser assembly 12 and/or to gantry 24 adjacent to leading row 36 of laser emitters 30. Correspondingly, slot extruder 14b is operably mounted to laser assembly 12 and/or to gantry 24 adjacent to trailing row 38 of laser emitters 30. This arrangement allows laser assembly 12 to operate with bidirectional printing.

Slot extruders 14 may each receive a supply of the photocurable resin from one or more material resin supply devices 40. Resin supply device(s) 40 may include one or more cartridges, reservoirs, and the like for retaining and feeding the photocurable resin to slot extruders 14 through feed lines 40a, preferably under positive pressure. For instance, the photocurable resin may be controllably pumped from resin supply device(s) 40 to slot extruders 14. In some embodiments, resin supply device(s) 40 may be integrally connected to slot extruders 14, and/or otherwise carried by gantry 24.

In some alternative embodiments, system 10 may operate with a single slot extruder 14 operably mounted to laser assembly 12 and/or to gantry 24 at the location of slot extruder 14a or slot extruder 14b. In other alternative embodiments, one or more slot extruders 14 may be mounted to an additional gantry (or gantries), where controller assembly 26 can command the additional gantry 24 to move the slot extruder(s) 14 independently of the movement of laser assembly 12. For example, controller assembly 26 may command a slot extruder 14 to pass over platform 20 and apply a resin film for a 3D part layer, and then move laser assembly 12 after the slot extruder 14 has completed its pass. This may be beneficial in situations where the resin film requires a small time period for the resin polymers to reach a relaxed state before the cross-linking.

In another example, the slot extruder(s) 14 may move along the y-axis by a separate gantry (not shown), substantially perpendicular to the movement directions of laser assembly 12 along the x-axis. This can be beneficial in system architectures where the x-axis dimensions and the y-axis dimensions of build envelope 34 are significantly different.

During the printing operation, controller assembly 26 may command platform gantry 22 to move platform 20 to a predetermined height along the z-axis. Controller assembly 26 may then command gantry 24 to move laser assembly 12 and slot extruders 14 along the x-axis in the direction of arrow 42 to traverse across platform 20.

While moving along the x-axis, controller assembly 26 may also command slot extruder 14a to extrude and apply a film of the photocurable resin onto platform 20 (or the top working surface of a partially-printed 3D part). As briefly discussed above, slot extruder 14a is preferably capable of extruding the flowable resin at high speeds with minimal or otherwise substantially reduced levels of normal forces or sheer forces applied to the surface. This allows the resin film to be applied with a substantially uniform z-height at the fast speeds.

While continuing to move along the x-axis, laser emitters 30 are then selectively and independently operated to emit laser beams on a voxel-by-voxel basis within build envelope 34. This selectively cross-links the resin film in a predefined voxel pattern to form a layer of the 3D part.

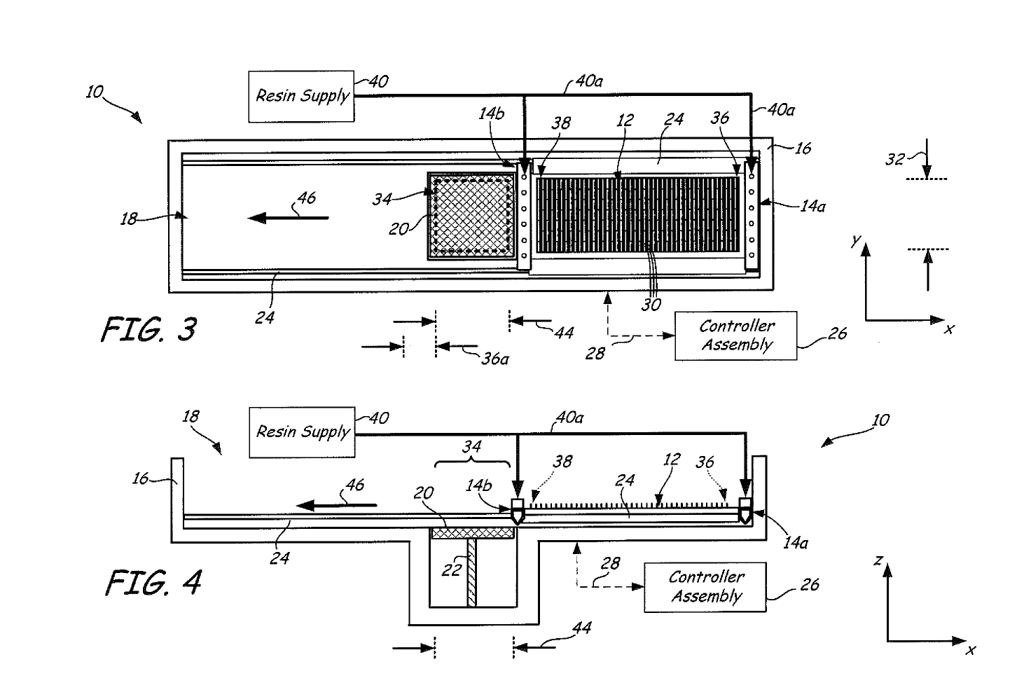

As shown in FIGS. 3 and 4, this process may continue until laser assembly 12 reaches the opposing, right-side, set position of overhead region 18. With laser assembly 12 at this right-side set position, the trailing row 38 of laser emitters 30 are located on the right side of build envelope 34 by a distance 38a (shown in FIG. 3), which also accounts for accelerations and decelerations of laser assembly 12 and slot extruders 14.

Accordingly, the x-axis limits for build envelope 34 correspond to scan length 44, which is preferably the distance over which laser assembly 12 and each slot extruder 14 can pass across at a substantially steady rate of movement. As such, laser assembly 12 preferably moves in the direction of arrow 42 to traverse distance 36a (shown in FIG. 1) for acceleration, scan length 44 for printing at a substantially steady rate of movement, and distance 38a (shown in FIG. 3) for deceleration. In other words, the cross-sectional area of build envelope 34 in which a 3D part may be printed can be defined by swath width 32 and scan length 44.

Once laser assembly 12 reaches the right-side set position, controller assembly 26 may command platform gantry 22 to move platform 20 downward by a single layer increment along the z-axis. Controller assembly 26 may then command gantry 24 to move laser assembly 12 and slot extruders 14 back along the x-axis in the direction of arrow 46 to traverse across platform 20.

While moving along the x-axis, controller assembly 26 may command slot extruder 14b to extrude and apply a film of the photocurable resin onto the surface of the previously-formed layer. Laser emitters 30 may again be selectively and independently operated to emit laser beams on a voxel-by-voxel basis within build envelope 34. This selectively cross-links the resin film in a predefined voxel pattern to form the next layer of the 3D part, which bonds to the previously-formed layer.

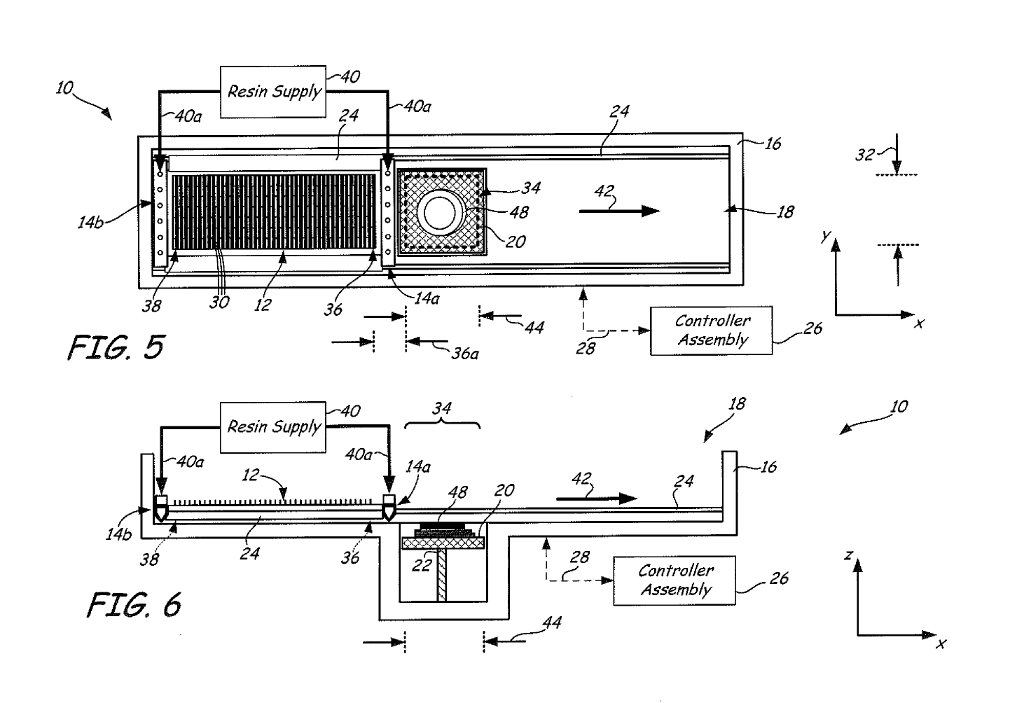

As shown in FIGS. 5 and 6, this back-and-forth process may be repeated for each layer until the 3D part (referred to as 3D part 48) is completed. Afterwards, 3D part 48 may be removed from system 10 and undergo one or more post-processing steps, such as resin removal and/or post-curing steps.

In an alternative control scheme, the trailing slot extruder 14 may be commanded to extrude and apply a film of the photocurable resin onto the surface of the previously-formed layer (rather than the leading slot extruder 14, as described above). In this alternative scheme, controller assembly 26 may initially command gantry 24 to move laser assembly 12 and slot extruders 14 the x-axis in the direction of arrow 42 to traverse across platform 20 (as shown in FIGS. 1 and 2). During this initial step, the leading slot extruder 14a does not extrude any photocurable resin and laser assembly 12 does not emit any laser beams.

Instead, controller assembly 26 may command the trailing slot extruder 14b to extrude and apply a film of the photocurable resin onto platform 20 (or the top working surface of a partially-printed 3D part). Then, during the next pass along the x-axis in the direction of arrow 46 (as shown in FIGS. 3 and 4), controller assembly 26 may command laser emitters 30 to be selectively and independently emit laser beams on a voxel-by-voxel basis within build envelope 34. This selectively cross-links the previously-applied resin film in a predefined voxel pattern to form the next layer of the 3D part.

In this step, the leading slot extruder 14b does not extrude any photocurable resin. Rather, the trailing slot extruder 14a may be commanded to extrude and apply a film of the photocurable resin onto the surface of the previous cross-linked layer. This process may then be repeated such that the resin film for the next layer is applied during the same pass that is used to cross-link the current layer.

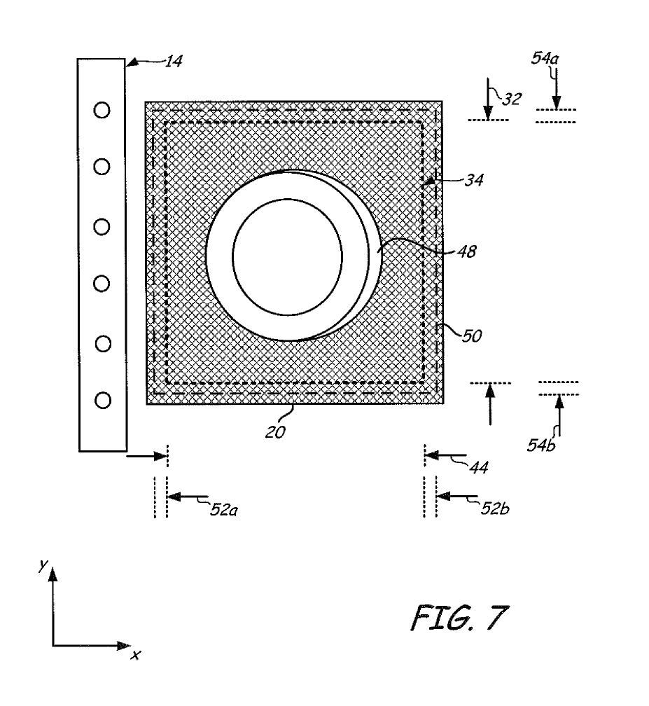

Furthermore, as shown in FIG. 7, slot extruders 14 are preferably capable of extruding and applying each resin film, referred to as resin film 50, with widths (along the y-axis) and scan lengths (along the x-axis) that are outside of the perimeter of build envelope 34. This arrangement allows the edges of each resin film 50, which can exhibit non-uniform undulations, thickness anomalies, and other geometrical variations to occur outside of build envelope 34.

For instance, slot extruders 14 may begin extruding and applying each resin film 50 prior to reaching build envelope 34 along the x-axis, and stop extruding and applying the resin film 50 after exiting build envelope 34 along the x-axis. This can provide x-axis edge regions 52a and 52b for each resin film 50. Correspondingly, the spans of slot extruders 14 along the y-axis preferably extend past the opposing edges of build envelope 34 along the y-axis, such that the lateral span of each resin film 50 can extend beyond swath width 32. This can provide y-axis edge regions 54a and 54b for each film 50. The dimensions of x-axis edge regions 52a and 52b, and of y-axis edge regions 54a and 54b, preferably ensure that any non-uniform undulations, thickness anomalies, and other geometrical variations that can occur at the edges of resin film 50 are located outside of build envelope 34.

The example shown in FIG. 7 is suitable for 3D parts 48 have footprint sizes similar to the dimensions of build envelope 34, and/or for applications where each resin film 50 is applied with the same cross-sectional dimensions regardless of the footprint sizes of the 3D parts 48. However, in many cases, the cross-sectional dimensions of 3D part 48 (or multiple 3D parts 48) can be smaller than the dimensions of build envelope 34. As such, in some embodiments, controller assembly 26 may command slot extruders 14 to extrude and apply resin films 50 with smaller cross-sectional dimensions, but that still have edge regions corresponding to edge regions 52a, 52b, 54a, and 54b that are outside of the layer perimeters of 3D parts 48.

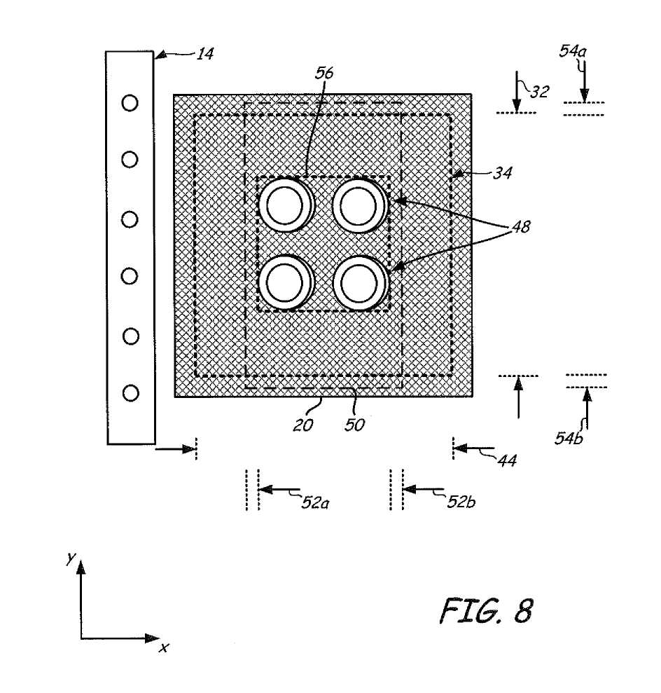

This is illustrated in FIG. 8, where four 3D parts 48 are being printed simultaneously. In this case, 3D parts 48 have a combined footprint perimeter 56, which is smaller than the dimensions of build envelope 34. As such, controller assembly 26 may command slot extruders 14 to extrude and apply resin films 50 with the smaller cross-sectional dimensions along the x-axis, as shown, such that edge regions 52a, 52b, 54a, and 54b each remain outside of footprint perimeter 56.

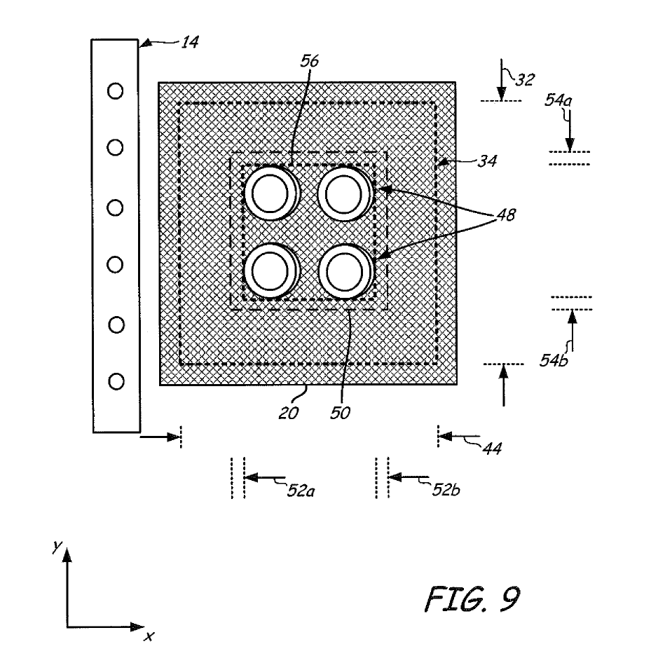

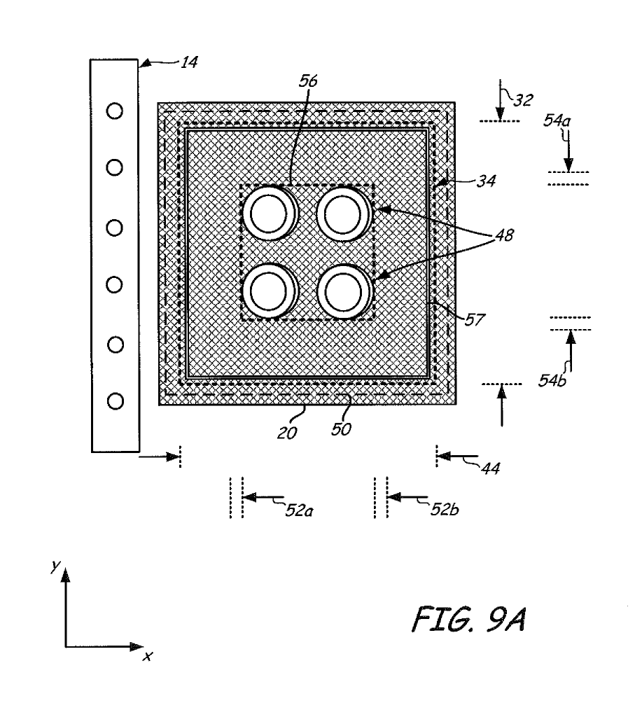

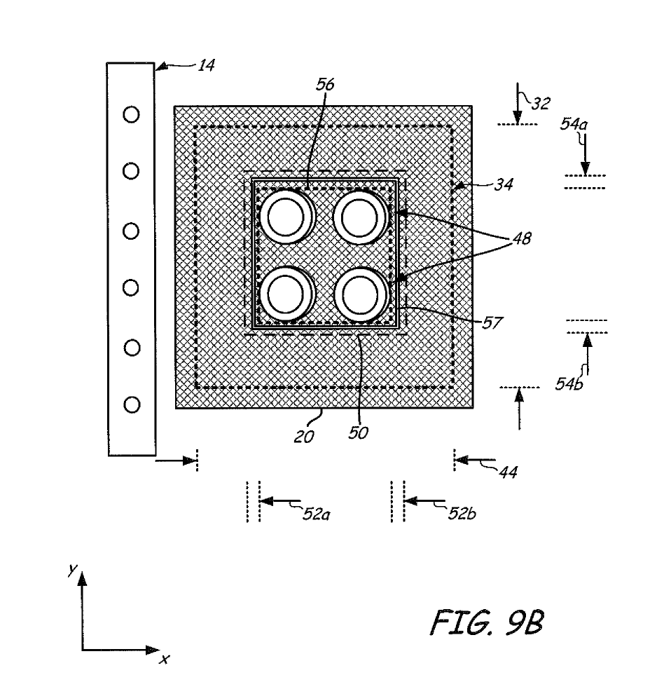

Additionally, in some embodiments, as discussed below, slot extruders 14 may be selectively operated along their y-axis spans, allowing each resin film 50 to have smaller spans along the y-axis. This is illustrated in FIG. 9, where controller assembly 26 may command slot extruders 14 to extrude and apply resin films 50 with the smaller cross-sectional dimensions along the x-axis and/or the y-axis, as shown. In this case edge regions 52a, 52b, 54a, and 54b may each remain outside of footprint perimeter 56. As can be appreciated, this dynamic sizing of resin films 50 as shown in FIGS. 8 and 9 can change with the dimensions of each layer (for sets of layers) for 3D parts 48, thereby reducing the amount of the photocurable resin that is consumed per pass.

As can be appreciated, because the resin is a flowable material, the edges of resin film 50 will typically require lateral containment. In some embodiments, platform 20 may lower into a tank (e.g., as shown in FIG. 1) having lateral walls that can contain the flowable resin of film 50. However, in some embodiments, system 10 may incorporate a dike-forming technique for containing the resin. In these embodiments, laser assembly 12 can cure a perimeter portion of each resin film 50 to print a containment dike 57 at any suitable location between footprint perimeter 56 and the perimeter edge of resin film 50.

For example, laser assembly 12 can print the geometry of containment dike 57 at or adjacent to build envelope 34 (as shown in FIG. 9A), adjacent to and outside of footprint perimeter 56 (as shown in FIG. 9B), any locations in-between, and the like. Additionally, containment dike 56 can have any suitable geometry, where square geometries and rectangular geometries are typical. This dike-forming technique is particularly suitable for use with laser assembly 12 (and/or other bitslice-based imagers) as it does not detrimentally affect the printing speeds of laser assembly 12. It also allows reduced volumes of the resin to be extruded, thereby reducing material consumptions.

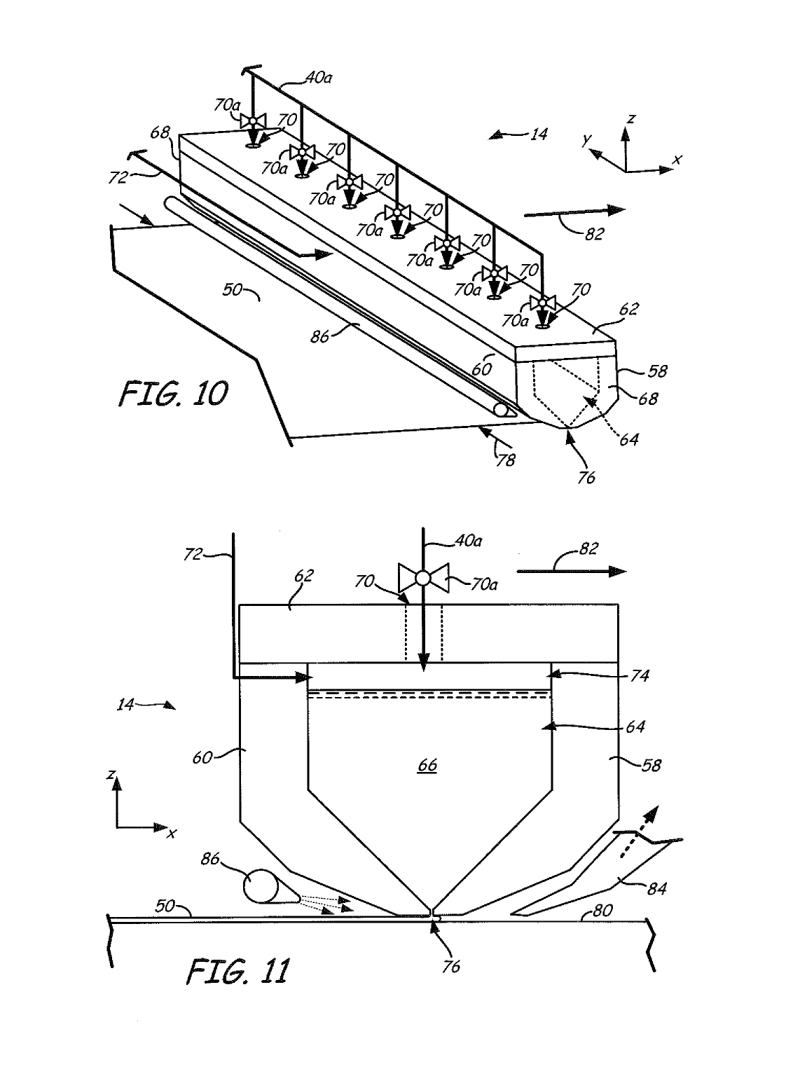

FIGS. 10-12 illustrates an exemplary embodiment for slot extruder 14, which may apply to both slot extruders 14a and 14b. As illustrated in FIGS. 10 and 11, slot extruder 14 may include upstream sidewall 58, downstream sidewall 60, and top cover 62, all of which are secured together to define an interior plenum 64 for retaining a supply of photocurable resin 66. As illustrated in FIG. 10, slot extruder 14 also includes opposing end walls 68 that cap interior plenum 64. Upstream sidewall 58, downstream sidewall 60, top cover 62, and opposing end walls 68 may each be fabricated from one or more rigid materials, such as one or more polymeric and/or metallic materials.

Top cover 62 may include a plurality of inlet ports 70 for receiving a plurality of supplies of resin 66 from feed lines 40a. While illustrated with six inlet ports 70 extending through top cover 62, slot extruder 14 may alternatively include any suitable number of inlet ports 70 (e.g., one or more inlet ports 70), which may extend through top cover 62 and/or any other suitable location of slot extruder 14.

In some preferred embodiments, feed lines 40a and/or inlet ports 70 may include controllable pumps and/or valves 70a, which can communicate with controller assembly 26 over communication line(s) 28. This preferably allows controller assembly 26 to independently control each pump/valve 70a to independently regulate the flows of resin 66 through the separate inlet ports 70. Furthermore, in some additional embodiments, feed lines 40a are sealed (e.g., hermetically sealed) to inlet ports 70 to prevent resin 66 and retained pressurized air from leaking out of plenum 64.

Slot extruder 14 may also include a gas inlet line 72 for introducing pressurized air (or other gases, such as an inert gas) into an overhead region 74 of plenum 64, above the fill level of resin 66. As discussed below, the pressurized air can assist in reducing pressure drops along the y-axis span of plenum 64, and to provide a positive internal pressure within plenum 64 for extruding resin 66 from slot extruder 14 as resin film 50.

In the shown example, upstream sidewall 58 and downstream sidewall 60 converge at the bottom side to define slot 76 at the base of plenum 64. Slot 76 preferably extends linearly along the y-axis. However, in some embodiments, slot 76 may have a small non-linear bowing or curvature, if desired. The span distance for slot 76 (and plenum 64) is preferably long enough to extrude and apply resin film 50 with a y-axis span that is capable of extending beyond the y-axis perimeter of build envelope 34, such as by edge regions 54a and 54b (e.g., as shown above in FIGS. 7 and 8).

Examples of suitable span distances 78 for slot 76 and plenum 64 include those greater than about 1 foot, greater than about 2 feet, and/or greater than about 3 feet. In some embodiments, span distance 78 ranges from about 1 foot to about 4 feet, from about 2 feet to about 4 feet, and/or from about 3 feet to about 4 feet. In other embodiments, span distance 78 may be larger, such as from about 4 feet to about 20 feet, from about 6 feet to about 15 feet, and/or from about 8 feet to about 12 feet.

As discussed below, resin 66 typically has a substantially uniform and known viscosity suitable for laminar-flow extrusion. At the known viscosity and a constant applied pressure (from air inlet line 72), resin 66 is forced from plenum 64, through slot 76 where it is subjected to shear forces, and extruded onto a working surface 80. Working surface 80 (shown in FIG. 11) may be the top surface of platform 20 and/or the top working surface of 3D part 48).

As slot extruder 14 is moved along the x-axis in the direction of arrow 82 (corresponding to either arrow 42 or arrow 46), the extruded resin 66 is applied onto working surface 78 with minimal lateral and normal forces to produce resin film 50 having a substantially uniform thickness (outside of edge regions 52a, 52b, 54a, and 54b). Slot extruder 14 can optionally operate in combination with vacuum slot 84 and air knife unit 86, each of which may extend along the y-axis by span distance 78. Vacuum slot 84 preferably draws a weak vacuum upstream of slot 76, and air knife unit 86 preferably applies a weak air knife downstream of slot 76. This combination eliminates or otherwise reduces air bubbles from becoming trapped under the applied resin film 50 as slot extruder 14 moves along the x-axis.

Furthermore, in some embodiments, the pressurized air from air knife unit 86 optionally may be operated in conjunction with a refrigeration unit (not shown) or other suitable heat exchange unit for chilling the air. This can assist in cooling the resin films 50 prior to and/or after curing. Furthermore, in embodiments that incorporate multiple slot extruders 14 (e.g., as shown in FIGS. 1-6), each slot extruder 14 may include its own air knife unit 86 for blowing the chilled air on the printed 3D part 48 during each bidirectional pass over platform 20.

Moreover, in further embodiments, each air knife unit 86 may also function as a series of air gauges, which can measure back pressure of the emitted air as it blows across each resin film 50. The measured back pressures can accordingly provide a non-contact technique for measuring the gap between the slot of air knife unit 86 and the surface of resin film 50. These measurement signals can be transmitted over communication line(s) 28 to controller assembly 26, which can then use the measurement signals to detect the height of each resin film 50.

Based on these detected heights, controller assembly 26 can then adjust the extrusion profiles of slot extruders 14 to correct for height deviations. This can be particularly beneficial for preventing layer height errors from accumulating over multiple passes. In additional embodiments, system 10 and controller assembly 12 may also correct for voxel height errors using one or more imaging sensors, such as disclosed in Comb et al., U.S. Patent Publication No. 2015/0266242, entitled “Additive Manufacturing With Virtual Planarization Control”, the disclosure of which is incorporated by reference in its entirety.

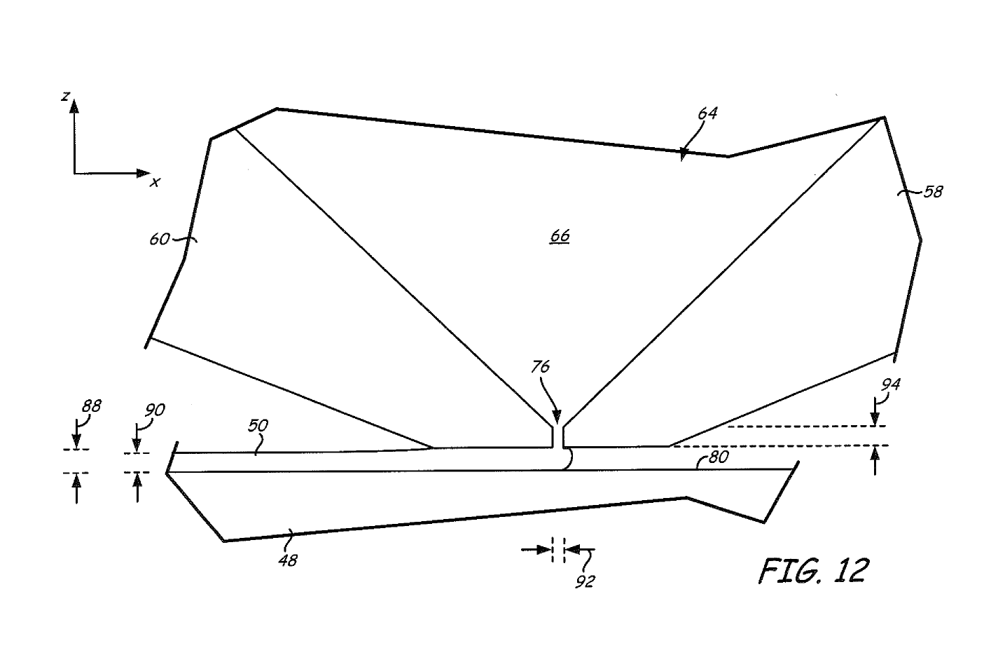

As shown in FIG. 12, the bottom of slot 76 (and slot extruder 14) may pass over working surface 80 by an average gap distance 88 along the z-axis, which may be any suitable distance that allows resin film 50 to be extruded and applied to working surface 80, preferably at high speeds, with minimal or otherwise reduced levels of shear or normal forces applied to working surface 80. While extruding, resin 66 is sheared while flowing through slot 76 to partially define the thickness for resin film 50 (referred to as film thickness 90). This is achieved by the dimensions of slot 76, referred to as slot width 92 along the x-axis and slot height 94 along the z-axis. In preferred embodiments, slot width 92 and slot height 94 each have less than 10% variation along the y-axis (i.e., along span distance 78), and more preferably are each substantially uniform along the y-axis.

The shearing of resin 66 in slot 76 allows the resulting resin film 50 to be applied onto working surface 80 with minimal (or otherwise reduced) amounts of normal and lateral forces. This allows 3D part 48 to be printed from resin 66 have a high viscosity, thin layers, high printing speeds, and short layer times, without the risk of damaging or distorting the previously-printed layers.

As resin 66 exits slot 76, its polymeric chains typically undergo a relaxation phase that generate a die swell effect that increases the thickness of the extruded resin 66 beyond slot width 92. As such, in some embodiments, slot width 92 is preferably smaller than the desired film thickness 90 for resin film 50 to account for the die swell effect. Examples of suitable average dimensions for slot width 92 range from about 10 micrometers to about 200 micrometers, from about 20 micrometers to about 100 micrometers, and/or from about 20 micrometers to about 50 micrometers. With reference to the desired film thickness 90, the average dimensions for slot width 92 range from about 80% to about 100%, from about 90% to about 100%, and/or from about 95% to about 100% of the average film thickness 90.

In some embodiments, slot 76 is positioned close to working surface 80, such as from about one to about two times the average film thickness 90. In these embodiments, the presence of working surface 80 can create a small additional flow resistance that can increase monotonically with gap distance 88. This flow resistance can usefully provide flow leveling feedback that tends to fill in depressions and under-apply a layer thickness to elevated portions of the 3D part 48 being printed.

Back pressure leveling of the extruded film allows for compensation for required changes in flow rate for different regions of the part being printed. When the back pressure between part being printed and the pressure in the plenum 66 is increased, the driving force (caused by a difference in pressure) is decreased and results in a decrease in flow rate. When the back pressure between the part being printed and the pressure in the plenum 66 is decreased, the driving force is increased and results in an increase in flow rate. Therefore, the pressure within the plenum 66 can be manipulated to control the flow rate of the photopolymer resin as the film of resin is extruded to accommodate for, by way of example, a change in a level of the photocurable resin within the plenum 66. In some embodiments, the back pressure from the flow of photocurable resin interacting with the part surface is at least about 5% of the total pressure drop from the pressure in the plenum 66 measured at a top surface of the photopolymer resin pool within the plenum 66 to ambient pressure which is typically atmospheric pressure.

Since the bottom of slot extruder 14 that is closest to working surface 80 is essentially a knife edge, the draw down of the extruded resin 66 is typically less than the film thickness 90. On the other hand, as mentioned above, die swell can cause the natural film thickness 90 to be greater than slot width 92. However, some residual in-plane tension can allow the extruded resin 66 to bridge voids in the 3D part 48 being printed.

In some embodiments, gap distance 88 is about 100% to about 120% of the film thickness 90, from about 100% to about 110% of the film thickness 90, from about 100% to about 105% of the film thickness 90, and/or is substantially the same as film thickness 90. It has been found that viscous drag of the extruded resin 66 against the trailing edge of slot 76 causes the extruded resin 66 to accumulate in front of slot 76 (referred to as “push”), which generates the additional pressure required to make film thickness 90 substantially the same as gap distance 88.

Moreover, this additional pressure can serve to better expel air, for example, from between the resin film 50 and the underlying working surface 80. Another advantage of this embodiment is that there is more feedback pressure from working surface 80 to doctor or level the resin film 50 in the presence of part surface undulations. Thus, as can be appreciated from the above discussion, gap distance 88 for slot 76 does not solely dictate the film thickness 90 for resin film 50.

The amount of pressure required to extrude resin 66 through slot 76 can generally follow a Poiseuille laminar flow profile, such as described in Equation 1:

$$Pressure = \frac{12 Q μ {H}_{Slot}}{{W}_{Slot}^{3} {D}_{Span}} \qquad ( Equation 1 )$$

where Q is the volumetric extrusion flow rate (volume/second), μ is the dynamic viscosity of resin 66, H_{Slot} is the slot height 94, W_{Slot} is the slot width 92 (cubed in Equation 1), and D_{Span} is the span distance 78 for slot 76.

For example, pushing the flowable resin 66 through slot 76 in a low-pressure situation (e.g., 10 inches/second flow rate, 0.1 Poise viscosity, 4-mil slot height, and 4-mil slot width) requires a pressure of about 0.04 pounds/square-inch (psi) applied evenly along span distance 78. Alternatively, a high-pressure situation (e.g., 150 inches/second flow rate, 10 Poise viscosity, 1-mil slot height, and 1-mil slot width) requires a pressure of about 260 psi applied evenly along span distance 78.

As can be appreciated, these variables can be modified to achieve a variety of different pressures between these low and high-pressure situations. For instance, in some embodiments, slot extruder 14 may have a slot width 92 and a slot height 94 each ranging from about 25 micrometers to about 50 micrometers, and be commanded to extrude the flowable resin 66 at a flow rate ranging about 50 inches/second to about 150 inches/second, where resin 66 may have a dynamic viscosity ranging from about 50 centipoise to about 5,000 centipoise.

Examples of suitable dimensions for slot height 94 range from about 50% to about 200% of slot width 92, from about 75% to about 150% of slot width 92, and/or from about 90% to about 110% of slot width 92. In some embodiments, slot height 94 is substantially the same length as slot width 92.

The length of slot 76 along the y-axis (e.g., span distance 78) is substantially greater than slot width 92. The length of slot 76 is preferably more than 5 times larger than slot width 92, more preferably more than 10 times larger than slot width 92, even more preferably more than 15 times larger than slot width 92. In some embodiments, the length of slot 76 is preferably more than 20 times larger than slot width 92, and in further embodiments, more than 30 times larger than slot width 92. For example, a length of slot 76 of one meter and a slot width 92 of 50 micrometers provides a factor of 20, and a length of slot 76 of one meter and a slot width 92 of 25 micrometers provides a factor of 40.

To extrude and apply resin film 50 having a substantially uniform thickness 90, the pressure and level of resin 66 in plenum 64 should be as uniform as possible. Otherwise, pressure variations along the length of plenum 64 can vary the volumetric extrusion rates of resin 66 though slot 76 at different points along span distance 78, which can result in thickness variations in resin film 50. These thickness variations may accordingly cause 3D part 48 to accumulate surface undulations, such as hills and valleys, over successive layers that can reduce part quality.

However, due to its long dimensions, plenum 64 can exhibit pressure drops in the flowing resin 66 along its length. In some embodiments, slot extruder 14 may include the gas inlet line 72 (shown in FIGS. 10 and 11) for introducing pressurized air (or other gases, such as an inert gas) into overhead region 74 of plenum 64, above the fill level of resin 66. The pressurized air can provide a constant positive pressure buffer along the length of plenum 64 to assist in reducing pressure fluctations along its length. This is in addition to providing the positive internal pressure for extruding resin 66 from slot 76 when commanded by controller assembly 26.

In addition to the pressurized air, slot extruder 14 may also include multiple inlet ports 70 and pumps/valves 70a (best shown above in FIG. 10), as discussed above. This allows controller assembly 26 to independently regulate the flows of resin 66 through the separate inlet ports 70, such as in response to measured local fill levels. For example, as discussed below, in some embodiments, slot extruder 14 may include multiple capacitance sensors distributed along the length of plenum 64 to measure local fill levels of resin 66 in plenum 64.

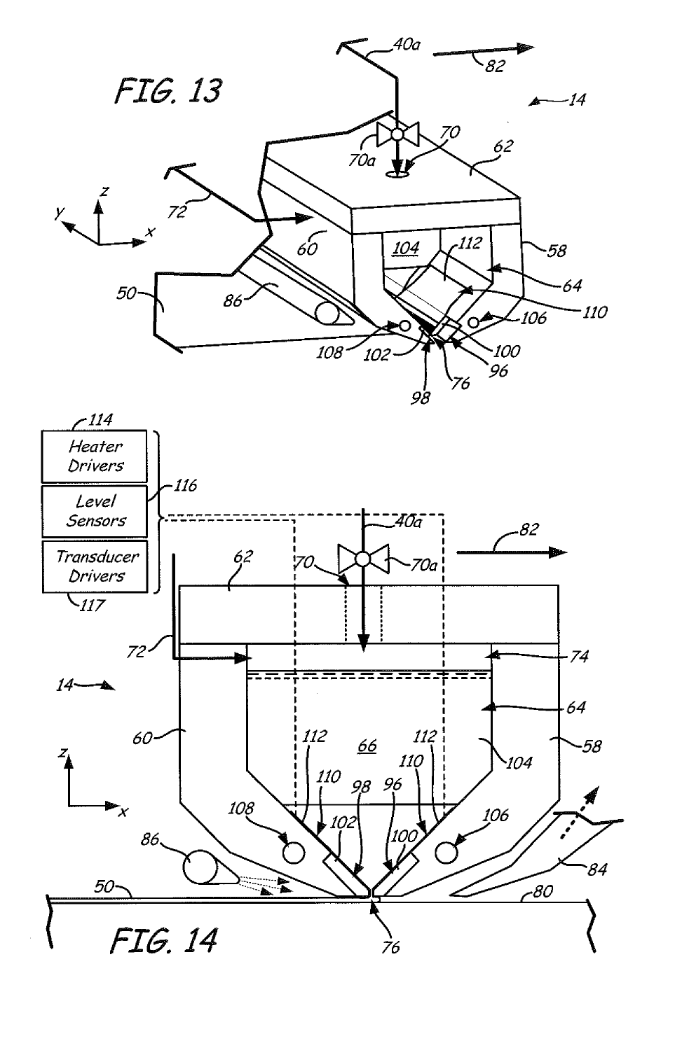

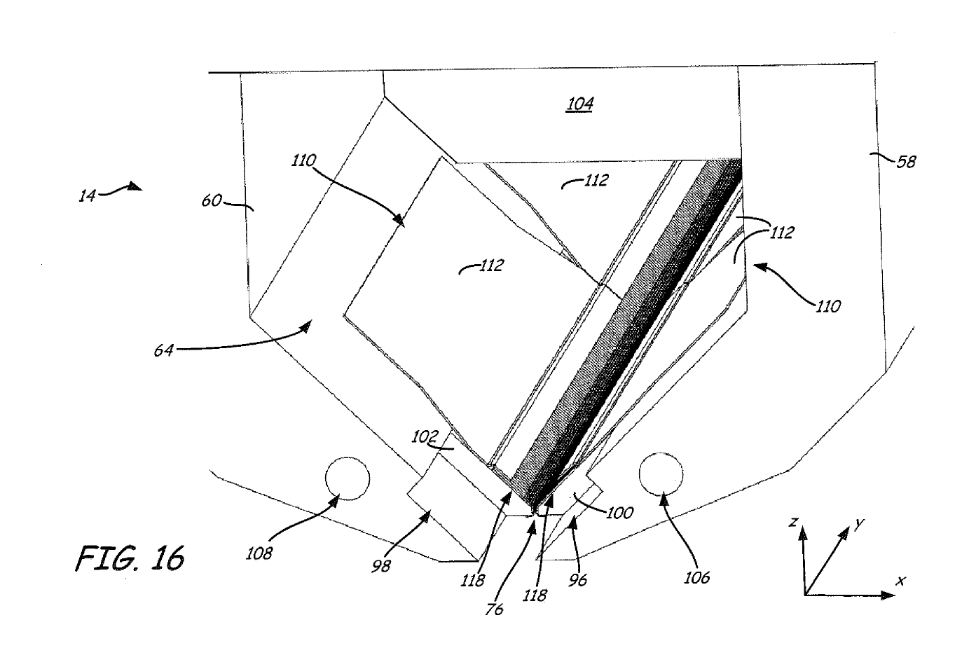

FIGS. 13-18 illustrate a preferred architecture for slot extruder 14, which can incorporate capacitance sensing and resin heating. As illustrated in FIGS. 13-15, upstream sidewall 58 and downstream sidewall 60 respectively include indentations 96 and 98 each extending along the y-axis. Indentations 96 and 98 themselves respectively retain plates 100 and 102 that also extend along the y-axis, and may be fabricated from one or more ceramic materials. Accordingly, plates 100 and 102 are the portions of slot extruder 14 that primarily define the width and length of slot 76, rather than upstream sidewall 58 and downstream sidewall 60.

As further illustrated, plenum 64 is separated along its length by a plurality of spaced apart reinforcing supports 104 that stiffen slot extruder 14, while also allowing resin 66 to flow along the length of plenum 64 to maintain a substantially uniform pressure and fill level. Upstream sidewall 58 and downstream sidewall 60 may also respectively include coolant ports 106 and 108. This allows coolant fluids to flow from a heat exchange unit (not shown) and through upstream sidewall 58 and downstream sidewall 60, as discussed below.

Each side of slot extruder 14 may also includes a heater array assembly 110 extending along the length of plenum 64. Each heater array assembly 110 may includes a series of adjacent flex circuits 112 that can propagate out of plenum 64 to communicate with heater drivers 114 and capacitance level sensors 116 (depicted in FIG. 14), each which may communicate with controller assembly 26 over communication line(s) 28.

In some embodiments, slot extruder 14 may also include one or more ultrasonic transducers (not shown) at slot 76 to further assist in extruding resin 66. For instance, each heater array assembly 110 may optionally include one or more ultrasonic transducer(s) at or near slot 76. In these embodiments, flex circuits 112 that can propagate out of plenum 64 can also communicate with transducer drivers 117 (depicted in FIG. 14), which may also communicate with controller assembly 26 over communication line(s) 28.

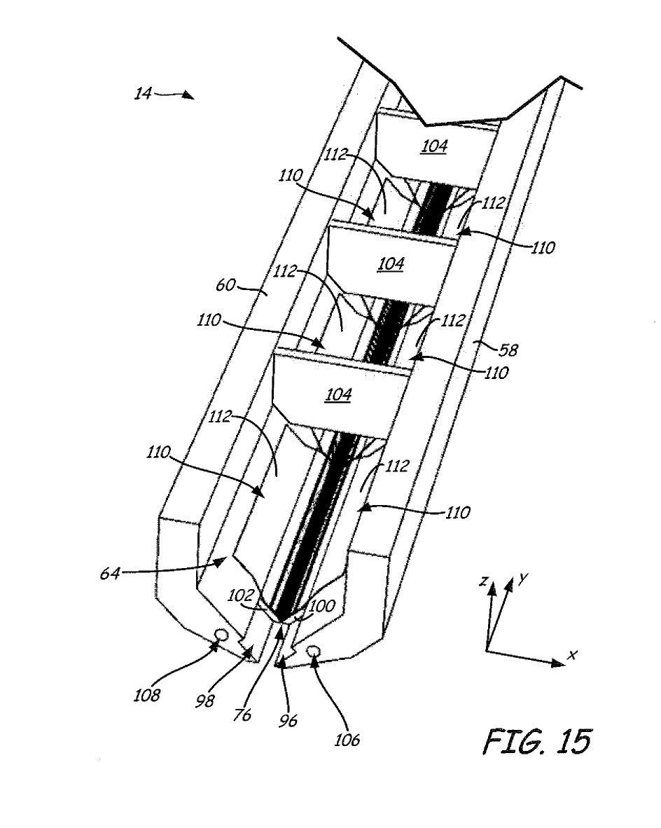

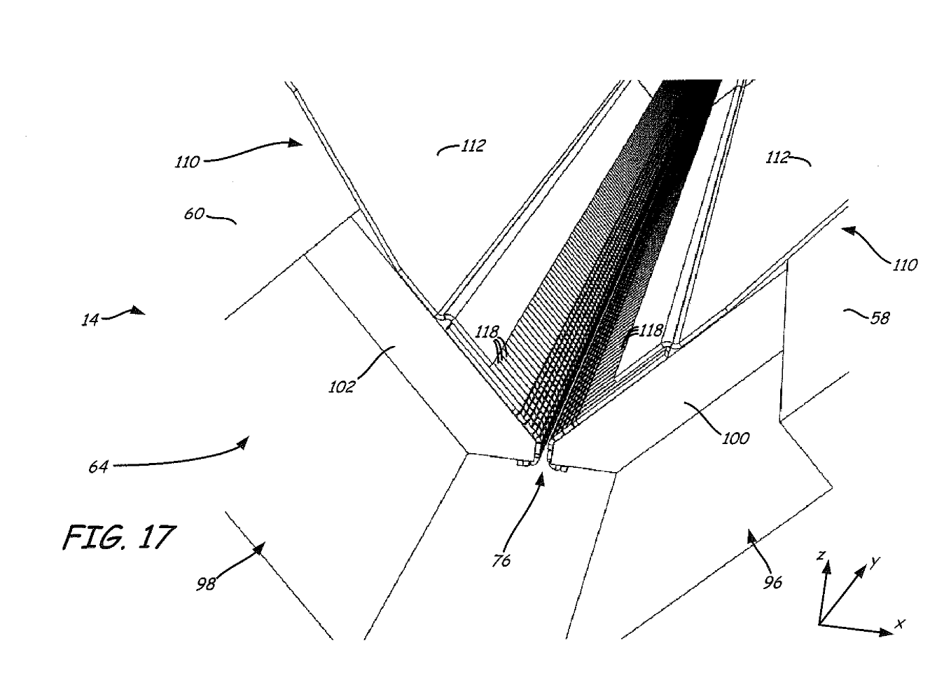

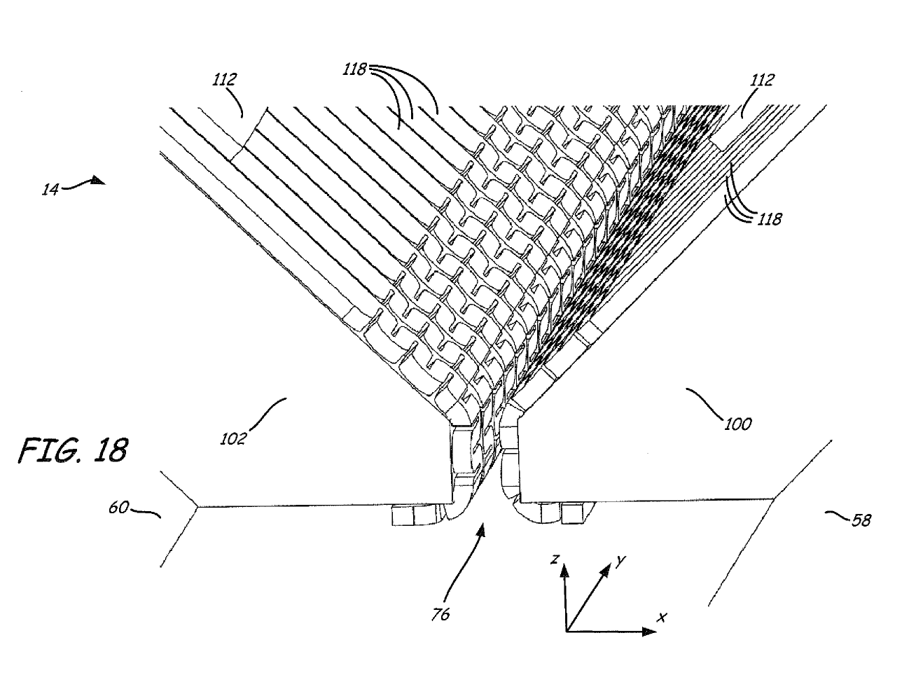

As best illustrated in FIGS. 15-17, flex circuits 112 may be secured to sidewalls 58 and 60, as well as to plates 100 and 102, and connect multiple adjacent heater elements 118 (best shown in FIGS. 17 and 18) to heater drivers 114 and capacitance level sensors 116. As shown in FIG. 18, each heater element 118 can include a lithographed-serpentine geometry that is positioned down and through slot 76.

During operation, controller assembly 26 and/or heater drivers 114 can selectively apply electrical power to heater elements 118, which heats the powered heater elements 118. This heat may then transfer to the resin 66 in plenum 64, particularly proximate region 66 adjacent to heater elements 118.

Even in embodiments in which resin 66 does not behave as a thermoplastic material, its viscosity will generally decrease when heated. As such, this arrangement provides a local electronically-addressable ability to cause flow to stop along the length of slot 76. During an extrusion run, heater elements 118 may heat up resin 66 adjacent to slot 76, and the air pressure within plenum 64 may be increased (via air line 72) to drive resin 66 through slot 76. While passing through slot 76, resin 66 is heated and sheared to a desired viscosity for extrusion as resin film 50. After the extrusion run is completed, the applied pressure may be reduced and heater elements 118 may be turned off. This allows the coolant fluid flowing through coolant conduits 106 and 108 to locally cool the resin 66 residing in plenum 64 to a more viscous state, thereby controllably preventing resin 66 from flowing through slot 76.

Because heater elements 118 can be selectively operated, in some cases, slot extruder 14 can extrude resin 66 form less than the entire length of slot 76, such as discussed above for the smaller resin films 50 (e.g., shown above in FIG. 9). This selectively extrusion for resin film 50 can be beneficial for a variety of applications.

Additionally, heater array assemblies 110 may also communicate with capacitive level sensors 116 to indicate the local level of resin 66 along the length of plenum 64. In particular, the capacitance of resin 66 at various locations along the length of plenum 64 can be monitored to identify variations in fill levels. If these variations are detected, controller assembly 26 can direct feed lines 40a and/or pumps/valves 70a to operate to introduce additional amounts of resin 66 to plenum 64 at the identified lower-filled locations. This can assist in maintaining substantially uniform fill levels for resin 66, which can accordingly increase the uniformity of pressure along the length of slot 76 (i.e., to prevent local pressure drops).

The capacitance level sensing can also be used to provide feedback on the flow rate during an extrusion run. In this case, the extrusion flow rate through slot 76 can be linked to the drive pressure in plenum 64 by measuring the flow, such as by capacitively monitoring the change in the resin level inside plenum 64 during while extruding. In other embodiments, film thickness 90 of resin film 50 may also be monitored with trailing optical, capacitive, and/or acoustic sensors (not shown). These external sensors can also be used in a feedback loop to control the drive pressure in plenum 64.

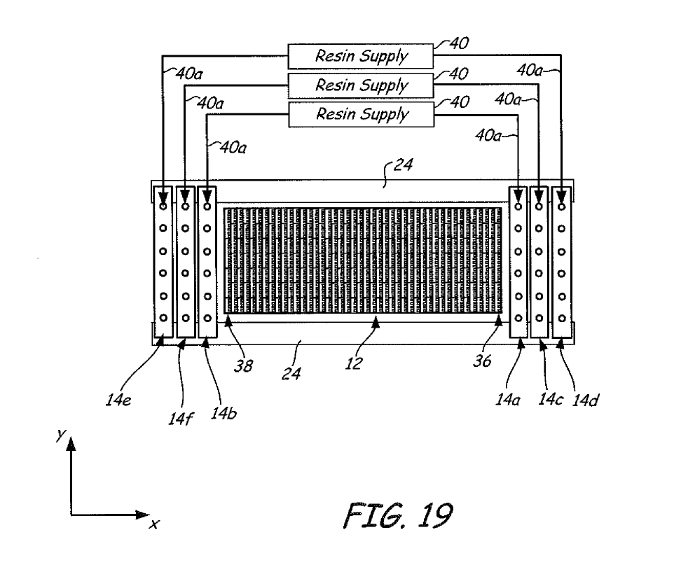

FIG. 19 illustrates an alternative embodiment, which includes multiple slot extruders 14 on each end of laser assembly 12, such as for multiple-material applications. This embodiment is particularly beneficial in combination the embodiment discussed above having the selective extrusion along the length of slot 76 (shown above in FIGS. 13-18). In this case, slot extruders 14a and 14b may each include a first resin 66, slot extruders 14c and 14f may include a second resin 66, and slot extruders 14d and 14e may include a third resin 66. The first, second, and third resins 66 may be the same materials or different materials, as desired.

The selective extrusion of each slot extruder 14 allows the different resins 66 to be selectively extruded onto platform 20 or working surface 80 of 3D part 48. This allows multiple photocurable resins to be used, such as resins with different functional properties (e.g., different strengths, flexibilities, and the like) as well as resins with different colors.

In some embodiments, the sets of slot extruders 14 (e.g., slot extruders 14e, 14f, and 14b) may extrude their resins 66 during the same pass, effectively functioning as co-extruders. In alternative embodiments, each slot extruder 14 may be configured with multiple plenums 64 and slots 76 to function as a co-extruder. These co-extruder embodiments can provide a variety of different multi-film combinations for tailoring the physical and/or aesthetic properties of the 3D parts.

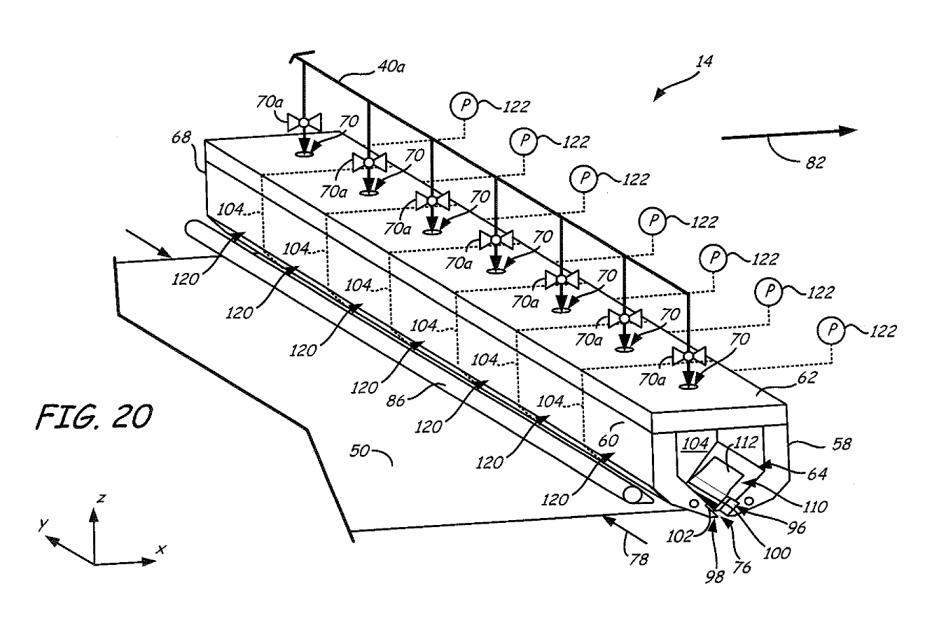

FIG. 20 illustrates another alternative embodiment, in which each slot extruder 14 may operate with a multiple-zone architecture. In this embodiment, plenum 64 may be separated into multiple zones 120, where each zone 120 may be aligned with one of the inlet ports 70 for controllably and independently receiving resin 66 from the associated feed line 40a. For example, reinforcing supports 104 can optionally extend down to slot 76 to separate plenum 64 into the multiple zones 120, where the span length of each zone 120 along the y-axis is preferably selected such that pressure drops associated with flow from the inlet ports 70 to any portion of slot 76 is substantially the same (e.g., within about 5% pressure variation).

As shown, air inlet line 72 (shown above in FIG. 10) may optionally be omitted. Instead of extruding based on gas pressure throughout plenum 64, each zone 120 is preferably filled with resin 66 up to inlet port 70 and feed line 7a (i.e., overhead region 74, shown above in FIG. 14, is omitted). As such, the pressure within each zone 120 can be controlled by the flow of resin 66 through inlet port 70, which can be independently regulated or metered with flow regulators 70a. The regulation or metering by flow regulators 70a can accordingly be made in response to pressure signals from one or more pressure sensors 122 located in each zone 120.

For example, each pressure sensor 122 can monitor the pressure of resin 66 in its associated zone 120, and transmit signals over communication lines 28 to controller assembly 26 (and/or to local control boards of controller assembly 26) corresponding to the monitored pressures. Based on the received pressure signals from each pressure sensor 122, controller assembly 26 can adjust the flow of the pressurized resin 66 into each zone 120 to preferably maintain a substantially uniform pressure across each zone 120.

In some preferred embodiments, flow regulators 70a operate with fluid pumps. In this case, controller assembly 26 may independently command each flow regulator 70a to selectively adjust the feed rate of resin 66 into is associated zone 120 to maintain a predefined pressure. The use of pump-based flow regulators 70a can be beneficial for pressurizing and depressurizing each zone 120, where depressurization can be obtained by reversing the flow of resin 66 with the pumps 70a, which can draw back the resin 66.

Resin 66 may be extruded through slot 76 by increasing the flow of resin 66 into each zone 120 with each associated flow regulator 70a. Because resin 66 is relatively incompressible compared to air or other gases, the direct pressurization and depressurization of resin 66 can increase the response time for extruding resin 66 through slot 76 and for halting the extrusion (e.g., by draw backs with pumps 70a). Additionally, this embodiment precludes the need to vent the pressurized air after each extrusion run.

Slot extruder 14 can otherwise operate in the same manner as discussed above for the previous embodiments. Accordingly, slot extruders 14 of the present disclosure can operate with a variety of different pressurization techniques for maintaining substantially uniform pressures across plenum 64, and for extruding resin 66 through slot 76.

With respect to the resin 66, system 10, laser system 12, and slot extruders 14 may print 3D parts (e.g., 3D part 48) from a variety of different photocurable resins, such as those used in stereolithography-based systems. For example, resin 66 may include one or more monomers and oligomers capable of polymerizing and cross-linking to change the flowable resin 66 of resin film 50 into a hardened, solid layer of 3D part 48. As discussed below, in some further embodiments, resin 66 may also include one or more (pre-polymerized) polymers having available cross-linking groups.

For ease of discussion, the monomers, oligomers, and polymers are collectively referred to as the reactant compounds. It is understood that reference to a monomer unit, such as “methyl methacrylate” may collectively refer to the methyl methacrylate monomer, an oligomer that is polymerized at least in part from the methyl methacrylate monomer, and a polymer that is polymerized at least in part from the methyl methacrylate monomer.

Examples of suitable reactant compounds for resin 66 include one or more (meth)acrylic compounds, epoxy-functional compounds, and combinations thereof. The particular reactant compounds used may vary depending on the photoinitiation architecture. For example, reactant compounds that cross-link with ethylenically-unsaturated groups (e.g., (meth)acrylate compounds) can polymerize and/or cross-link with the use of free radical photoinitiators. In comparison, epoxy-functional compounds can typically polymerize and/or cross-link with the use of cationic photoinitiators.

In embodiments that incorporate free radical polymerization and cross-linking, resin 66 may include one or more (meth)acrylic compounds, such as one or more (meth)acrylate monomers, oligomers, and polymers, and/or one or more (meth)acrylic acid monomers, oligomers, polymers. Examples of suitable (meth)acrylate monomers include methyl (meth)acrylate, ethyl (meth)acrylate, ethanediol di(meth)acrylate, trimethylolethane tri(meth)acrylate, propyl (meth)acrylate, isopropyl (meth)acrylate, propanediol di(meth)acrylate, trimethylolpropane tri(meth)acrylate, butyl (meth)acrylate, isobutyl (meth)acrylate, butanediol di(meth)acrylate, trimethylolbutane tri(meth)acrylate, hexyl (meth)acrylate, 2-ethylhexyl (meth)acrylate, cyclohexyl (meth)acrylate, hexanediol di(meth)acrylate, cyclohexanediol di(meth)acrylate, trimethylolhexane tri(meth)acrylate, benzyl (meth)acrylate, isobornyl (meth)acrylate, hydroxyethyl (meth)acrylate, hydroxypropyl (meth)acrylate, tetramethylol methane tetra(meth)acrylate, dipropylene glycol di(meth)acrylate, trimethylol hexane tri(meth)acrylate, pentaerythritol tetra(meth)acrylate, urethane (meth)acrylate, and mixtures thereof.

In embodiments that incorporate acid functionalities, examples of suitable (meth)acrylic acid monomers include ethylenically-unsaturated carboxylic acid monomers, such as acrylic acid, methacrylic acid, alpha-chloroacrylic acid, alpha-cyanoacrylic acid, crotonic acid, alpha-phenylacrylic acid, beta-acryloxypropionic acid, fumaric acid, maleic acid, sorbic acid, alpha-chlorosorbic acid, angelic acid, cinnamic acid, p-chlorocinnamic acid, beta-stearylacrylic acid, citraconic acid, mesaconic acid, glutaconic acid, aconitic acid, tricarboxyethylene, 2-methyl maleic acid, itaconic acid, 2-methyl itaconic acid, methyleneglutaric acid, and mixtures thereof.

In some embodiments, the reactant compounds may also include one or more ethylenically-unsaturated monomers to impart additional properties to 3D part 48, resin film 50, and/or resin 66. For instance, the monomers may include one or more ethylenically-unsaturated, hydroxyl-functional monomers, one or more ethylenically-unsaturated aromatic monomers, and the like. Examples of suitable ethylenically-unsaturated hydroxyl-functional monomers include (meth)acrylate monomers and vinyl monomers having one or more hydroxyl-functional groups.

The ethylenically-unsaturated aromatic monomers preferably include aromatic groups and ethylenically-unsaturated groups, such as aromatic vinyl monomers. Examples of suitable ethylenically-unsaturated aromatic monomers include styrene, methyl styrene, halostyrene, diallylphthalate, divinylbenzene, alpha-methylstyrene, vinyl toluene, vinyl naphthalene, and mixtures thereof. For ease of reference, the ethylenically-unsaturated aromatic monomers refer to non-acrylic-type monomers (e.g., vinyl monomers).

In embodiments that incorporate cationic polymerization and cross-linking, resin 66 may include one or more epoxy-functional monomers. Examples of suitable epoxy-functional monomers include aliphatic, cycloaliphatic, aromatic or heterocyclic monomers having, one average, at least about 1.0 polymerizable oxriane group per molecule, more preferably at least about 1.5 polymerizable oxriane groups per molecule, and even more preferably at least about 2.0 polymerizable oxriane group per molecule. The average number of oxriane groups per molecule is determined by dividing the total number of oxriane groups in the epoxy-functional monomers by the total number of epoxy-functional molecules present.

Examples of suitable epoxy-functional monomers include alkyl glycidyl ethers such as butyl glycidyl ether, cresyl glycidyl ether, p-terbutylphenyl glycidyl ether, polyfunctional glycidyl ethers such as diglycidyl ether of 1,4-butanedol, diglycidyl ether of neopentyl glycol, diglycidyl ether of cyclohexanedimethanol, trimethylol ethane triglycidyl ether, trimethylol propane triglycidyl ether, polyglycidyl ether of an aliphatic polyol, polyglycol diepoxide, other glycidyl ethers of polyhydric phenols obtained by reacting a polyhydric phenol with an excess of chlorohydrin, such as epichlorohydrin), and mixtures thereof.

Additional examples of epoxy-functional monomers include alkylene oxides (e.g., propylene oxide, styrene oxide, and butadiene oxide); and glycidyl esters (e.g., ethyl glycidate), those which contain cyclohexene oxide groups (e.g., epoxy cyclohexanecarboxylates), octadecylene oxide, epichlorohydrin, styrene oxide, vinyl cyclohexene oxide, glycidol, glycidylmethacrylate, diglycidyl ether of Bisphendl A, vinylcyclohexene dioxide, bis(3,4-epoxy-6-methylcyclohexylmethyl)adipate, bis(2,3-epoxycyclopentyl)ether, aliphatic epoxy modified from polypropylene glycol, dipentene dioxide, epoxidized polybutadiene, silicone resin containing epoxy functionality, 1 bis(3,4-epoxycyclohexyl)adipate, 2-(3,4-epoxycyclohexyl-5,5-spiro-3,4-epoxy)cyclohexane-metadioxane, vinylcyclohexene monoxide 1,2-epoxyhexadecane, and mixtures thereof. In further embodiments, the photocurable resin may include one or more epoxy-(meth)acrylate monomers, such as glycidyl (meth)acrylate.

In some preferred embodiments, resin 66 may also include one or more fillers, which can be beneficial for many purposes, such as increasing the viscosity (and/or modifying the rheology) of resin 66, increase the strength and chemical resistance of the printed 3D parts (e.g., 3D part 48), reducing layer shrinking and curl effects, and the like. In embodiments that include fillers, preferred concentrations of the fillers in resin 66 may include more than about 1% by weight, more than about 5% by weight, and/or more than about 10% by weight, based on an entire weight of resin 66. Preferred concentrations of the fillers in resin 66 may also include less than about 70% by weight, less than about 60% by weight, less than about 50% by weight, and/or less than about 40% by weight, based on the entire weight of resin 66.

As can be appreciated, due to the thin layers that can be produced by slot extruder 14 and laser assembly 12, the filler particles preferably have maximum particle diameters (or other sizes, such as fiber lengths) that are smaller than the layer thickness 90 produced by slot extruder 14 (shown in FIG. 12) and/or than the intended voxel dimensions. Furthermore, the maximum particle diameters or dimensions for the filler particles are preferably less than about 90%, more preferably less than about 80%, and even more preferably less than about 70% of the layer thickness 90. In some embodiments, the maximum particle diameters or dimensions for the filler particles are less than about 60% and/or less than about 50% of the layer thickness 90.

The filler particles can have a unimodial or polymodial (e.g., bimodal) particle size distribution. Furthermore, the particle size distribution(s) can be selected to increase packing densities of the filler particles by selecting smaller filler particle that can fill in interstitial voids between larger filler particles (along with the above-discussed monomers, oligomers, and/or polymers).

Examples of suitable fillers include quartz, nitrides (e.g., silicon nitride), feldspar, kaolin, talc, titania, calcium carbonate, magnesium carbonate, glass spheres, graphite, carbon black, carbon fiber, glass fiber, wollastonite, mica, alumina, silicon carbide, zirconium tungstate, and silica particles (e.g., silicas available under the trade designations “AEROSIL” from Degussa Corp., Akron, Ohio; and “CAB-O-SIL” from Cabot Corp., Tuscola, Ill.). One interesting characteristic of slot extruder 14 is that fiber-based fillers in the applied resin film 50 tend to orient randomly in the x-y plane of the layer, potentially increasing intralayer strengths and/or other properties for 3D parts.

In some preferred embodiments, the surfaces of the filler particles can also be treated with one or more coupling agents in order to enhance the bond between the filler particles and the reactant compounds of resin 66. For instance, the surfaces of the filler particles can be treated to couple functional groups (e.g., ethylenically-unsaturated groups and/or epoxy-functional groups), which can cross-link with the reactant compounds of resin 66. Examples of suitable coupling agents include gamma-methacryloxypropyltrimethoxysil ane, gamma-mercaptopropyltriethoxysilane, gamma-aminopropyltrimethoxysilane, and the like.

As mentioned above, in addition to monomers, the (meth)acrylic compounds may also include one or more oligomers and/or polymers pre-polymerized from the above-discussed monomers. This can be beneficial for increasing the viscosity of resin 66 for use with slot extruders 14. Additionally, the longer pre-polymerized chains do not shrink during the photocuring process in system 10, effectively allowing them to function as fillers for resin 66.

For instance, in some embodiments, resin 66 may include one or more copolymers pre-polymerized (i.e., prior to use in system 10) from monomers that include one or more (meth)acrylates, one or more (meth)acrylic acids, one or more ethylenically-unsaturated hydroxyl-functional monomers, and/or one or more ethylenically-unsaturated aromatic monomers. Preferably, these copolymers retain unreacted and available functional groups that can cross-link during the photocuring process in system 10. For example, the copolymers may be pre-polymerized with a free-radical polymerization reaction, and retain unreacted and available epoxy-functional groups (e.g., from glycidyl (meth)acrylate monomers). These epoxy-functional groups can then function as curing groups for cross-linking during the photocuring process in system 10 (i.e., a cationic cross-linking).

As discussed for the fillers, due to the thin layers that can be produced by slot extruder 14 and laser assembly 12, the pre-polymerized copolymers preferably have chain lengths that are smaller than the layer thickness 90 produced by slot extruder 14 (shown in FIG. 12) and/or than the intended voxel dimensions. Furthermore, the maximum chain lengths or dimensions for the pre-polymerized copolymers are preferably less than about 90%, more preferably less than about 80%, and even more preferably less than about 70% of the layer thickness 90. In some embodiments, the maximum chain lengths or dimensions for the pre-polymerized copolymers are less than about 60% and/or less than about 50% of the layer thickness 90.

Resin 66 also preferably includes one or more radiation-activated photoinitiators to initiate the polymerization and/or cross-linking of the reactant compounds (and optionally, the surface-treated filler particles). The photoinitiator is preferably selected to undergo a photoreaction upon absorption of light with an appropriate light wavelength, such as wavelengths in the ultraviolet, visible, and/or infrared spectrums (e.g., from the laser beams of laser emitters 30). In some embodiments, the photoinitiator is selected to undergo a photoreaction on absorption of ultraviolet-wavelength light. In other embodiments, the photoinitiator is selected to undergo a photoreaction upon absorption of infrared-wavelength light. In yet other embodiments, the photoinitiator is selected to undergo a photoreaction upon absorption of electron beam radiation.

The photoinitiator is also preferably selected based on the particular functional groups of the reactant compounds, such as free-radically-active functional groups (e.g., ethylenically-unsaturated groups) and cationically-active functional groups (e.g., epoxy-functional groups). For free-radically-active functional groups, suitable photoinitiators include radical photoinitiators, optionally combined with one or more photosensitizers and/or accelerators. Upon absportion of the laser beam radiation (from laser emitters 30), the radical photoinitiators decompose into free radicals. The free radicals accordingly initiate an addition polymerization and/or cross-linking at a local level (e.g., within the voxel illuminated by the laser beam).

Examples of suitable radical photoinitiators include hydroxy ketones, amino ketones, hydroxy ketone/benzophenones, carbonyl compounds (e.g., benzoin, a-methyl benzoin, anthraquinone, chloroanthraquinone, and acetophenone), sulfur compounds (e.g., diphenyl sulfide, diphenyl disulfide, and dithio-carbamate), polycyclic aromatic compounds (e.g., α-hloromethyl naphthalene and anthracene), and the like. Other suitable photoinitiators for polymerizing free radically photopolymerizable compositions include the class of phosphine oxides, such as bis(2,4,6-trimethylbenzoyl)phenyl phosphine oxide, bis(2,6-dimethoxybenzoyl)-(2,4,4-trimethylpentyl) phosphine oxide (CGI 403, Ciba Specialty Chemicals), a mixture of bis(2,6-dimethoxybenzoyl)-2,4,4-trimethylpentyl phosphine oxide and 2-hydroxy-2-methyl-1-phenylpropan-1-one, a mixture of bis(2,4,6-trimethylbenzoyl)phenyl phosphine oxide and 2-hydroxy-2-methyl-1-phenylpropane-1-one, ethyl 2,4,6-trimethylbenzylphenyl phosphinate, and the like.

For cationically-active functional groups, suitable photoinitiators include cationic photoinitiators. Upon absportion of the laser beam radiation (from laser emitters 30), the cationic photoinitiators react and produce acid compounds (e.g., Lewis acids and Bronsted acids). These acids then initiate a condensation polymerization and/or cross-linking at a local level (e.g., within the voxel illuminated by the laser beam).

Suitable cationic photoinitiators include onium salts (e.g., iodonium salts), diazonium salts, organometallic complexes, boron trifluoride/tetrahydrofuran, dimethylbenzyl esters, and the like. Examples of suitable onium salts include iodonium salts (e.g., diaryliodonium and triaryliodonium salts), sulfonium salts (e.g., triarylsulfonium salts), pyridium salts, phosphonium salts, quinolinium salts, and the like. Additional examples of suitable cationic photoinitiators include thioxanthone derivatives, benzolphosphine oxides, bis-acylphosphine oxides, hydroxaryl ketones, hydrophilic initiators (e.g., quarternary ammonium salts, sulphonates, and thiosulphates).

Furthermore, many photoinitiators are capable of initiating both free radical and cationic reactions. Additional examples of suitable photoinitiators include those available under the trade designation “IRGACURE” from BASF Schweiz AG, Ludwigshafen, Germany (formerly Ciba Specialty Chemicals). Examples of suitable concentrations of the photoinitiators in resin 66 may range from about 0.1% by weight to about 10% by weight, and more preferably from about 0.5% by weight to about 5% by weight, based on the entire weight of resin 66.

Resin 66 may also include one or more additional additives that are preferably soluble or dispersible in the reactant compounds, and that preferably do not interfere with the curing processes. Examples of suitable additional additives include colorants (e.g., pigments and dyes), polymer stabilizers (e.g., antioxidants, light sensitizers, ultraviolet absorbers, and antiozonants), heat stabilizers (e.g., organosulfur compounds), biodegradable additives, and combinations thereof. In embodiments that incorporate additional additives, the additional additives may collectively constitute from about 0.1% by weight to about 20% by weight of resin 66, more preferably from about 0.2% by weight to about 10% by weight, and even more preferably from about 0.5% by weight to about 5% by weight, based on the entire weight of resin 66.

Examples of suitable light sensitizers include those capable of absorbing light having wavelengths ranging from about 300 to about 1000 nanometers, such as ketones, coumarin dyes (e.g., ketocoumarins), xanthene dyes, acridine dyes, thiazole dyes, thiazine dyes, oxazine dyes, azine dyes, aminoketone dyes, porphyrins, aromatic polycyclic hydrocarbons, p-substituted aminostyryl ketone compounds, aminotriaryl methanes, merocyanines, squarylium dyes, and pyridinium dyes. Ketones (e.g., monoketones or alpha-diketones), ketocoumarins, aminoarylketones, and p-substituted aminostyryl ketone compounds are preferred sensitizers.

Resin 66 may be formulated to have any suitable dynamic (shear) viscosity. In some preferred embodiments, resin 66 may be formulated to have dynamic viscosities that are significantly higher than those typically used for stereolithography applications. the high viscosities can be beneficial for many purposes, such as for increased part strengths (e.g., due to the incorporation of higher molecular weight polymer chains and/or filler particles), deformation resistance of resin film 50, and the like.

Examples of suitable dynamic viscosities for resin 66 (in an uncured state) include those less than about 7,500 centipoise, more preferably less than about 6,000 centipoise, and in some embodiments less than about 5,000 centipoise. In some embodiments, additional examples of suitable dynamic viscosities for resin 66 (in an uncured state) include those greater than about 25 centipoise, and more preferably greater than about 50 centipoise.

In some particular embodiments, resin 66 may have a dynamic viscosity (in an uncured state) ranging from about 50 centipoise to about 500 centipoise. In other particular embodiments, resin 66 may have a dynamic viscosity (in an uncured state) ranging from about 500 centipoise to about 1,000 centipoise. In further particular embodiments, resin 66 may have a dynamic viscosity (in an uncured state) ranging from about 1,000 centipoise to about 2,500 centipoise. In further particular embodiments, resin 66 may have a dynamic viscosity (in an uncured state) ranging from about 2,500 centipoise to about 5,000 centipoise.

During the curing process with system 10 (or any other suitable additive manufacturing system), the absorbed radiation initiates the free radical and/or cationic reactions at the illuminated voxels of resin 66 in resin film 50. This polymerizes and/or cross-links the reactant compounds (and optionally, the surface-treated filler particles), which transitions resin 66 from the uncured state in which resin 66 is flowable and extrudable, to the cured state in which the cured resin film 50 becomes a hardened, solid layer of 3D part 48 that bonds to the previously produced layers. The resulting hardened, solid layer is then non-flowable and preferably hydrophobic (e.g., a contact angle greater than about 90 degrees) for use in the printed 3D part (e.g., 3D part 48).

Although the present disclosure has been described with reference to preferred embodiments, workers skilled in the art will recognize that changes may be made in form and detail without departing from the spirit and scope of the disclosure.

1. A slot extruder for use with an additive manufacturing system, the slot extruder comprising:
a plenum that is at least partially enclosed and configured to receive a photocurable resin;
a slot positioned at a bottom end of the plenum, and configured to receive the photocurable resin from the plenum, wherein the slot has an average slot width in a direction of movement of the slot extruder, and a span length in a second direction that is perpendicular to the direction of movement of the slot extruder, and wherein the span length more than about 5 times larger than the average slot width; and
one or more resin inlet ports extending into the plenum.

2. The slot extruder of claim 1, wherein the span length more than about 10 times larger than the average slot width.

3. The slot extruder of claim 2, wherein the span length is more than about 15 times larger than the average slot width.

4. The slot extruder of claim 1, and further comprising one or more feed lines connected to the one or more resin inlet ports.

5. The slot extruder of claim 4, wherein the one or more feed lines comprises one or more controllable pumps, one or more controllable valves, or both.

6. The slot extruder of claim 4, wherein the plenum is separated into multiple zones each being associated with at least one of the resin inlet ports and at least one of the feed lines.

7. The slot extruder of claim 1, and further comprising one or more gas inlet lines configured to introduce a pressurized gas into the plenum.

8. The slot extruder of claim 1, wherein the average slot width ranges from about 10 micrometers to about 200 micrometers.

9. The slot extruder of claim 8, wherein the average slot width ranges from about 20 micrometers to about 50 micrometers.

10. The slot extruder of claim 1, wherein the slot also has an average slot height that ranges from about 50% to about 200% of the slot width.

11. The slot extruder of claim 10, wherein the average slot height ranges from about 90% to about 110% of the slot width.

12. The slot extruder of claim 1, and further comprising one or more heater assemblies secured in the plenum.

13. The slot extruder of claim 12, and further comprising one or more level sensors, wherein the one or more heater assemblies are configured to communicate with the one or more level sensors.

14. The slot extruder of claim 13 and the one or more level sensors are configured to sense a level of the photocurable resin within the plemun wherein the sensed level is utilized to adjust a pressure in the plenum such that a back pressure from flow of the photocurable resin against a part being built is at least about 5% of the total pressure drop from the sensed level to ambient pressure.

15. The slot extruder of claim 12, wherein the heater assembly extends into or through the slot.

16. The slot extruder of claim 1, and further comprising one or more gas inlet lines configured to introduce a pressurized gas into the plenum to controllably extrude the photocurable resin.

17. A slot extruder for use with an additive manufacturing system, the slot extruder comprising:
one or more sidewalls that define regions comprising:
a plenum configured to extrude a photocurable resin;
an elongated slot configured to receive the photocurable resin from the plenum;
a top cover and opposing end walls connected to or integrally formed with the one or more sidewalls to define a volume of the plenum;
a plurality of resin inlet ports extending into the plenum; and
one or more heater assemblies secured within the plenum and configured to receive commands from a controller assembly of the additive manufacturing system.

18. The slot extruder of claim 17, wherein the elongated slot has a span length and an average slot width, and wherein the span length is more than about 5 times larger than the average slot width.

19. The slot extruder of claim 17, wherein the span length is more than about 15 times larger than the average slot width.

20. The slot extruder of claim 17, and further comprising one or more feed lines connected to the one or more resin inlet ports.

21. The slot extruder of claim 21, wherein the one or more feed lines comprise one or more controllable pumps, one or more controllable valves, or both.

22. The slot extruder of claim 17, and further comprising one or more heater drivers located outside of the plenum, wherein the one or more heater array assemblies are configured to communicate with the one or more heater drivers.

23. The slot extruder of claim 17, and further comprising one or more level sensors, wherein the one or more heater assemblies are configured to communicate with the one or more capacitance level sensors.

24. The slot extruder of claim 23 and the one or more level sensors are further configured to sense a level of the photocurable resin within the plemun wherein the sensed level is utilized to adjust a pressure in the plenum such that a back pressure from flow of the photocurable resin against a part being built is at least about 5% of the total pressure drop from the sensed level to ambient pressure.

25. The slot extruder of claim 17, wherein the one or more heater assemblies each include one or more heater elements.

26. The slot extruder of claim 25, wherein the one or more heater elements of each heater assembly is at least partially disposed in the plenum, and also extends into or through the slot.

27. The slot extruder of claim 26, wherein the one or more heater elements of each heater assembly comprises a serpentine geometry.

28. The slot extruder of claim 17, and further comprising one or more gas inlet lines configured to introduce a pressurized gas into the plenum.
